(19) United States
(12) Patent Application Publication
(10) Pub. No.: US 2026/0119366 A1
(43) Pub. Date: Apr. 30, 2026

(54) JOINT PERFORMANCE-POWER OPTIMIZATION FRAMEWORK FOR NEURAL PROCESSING UNIT BASED ARTIFICIAL INTELLIGENCE INFERENCE

(71) Applicants: Yang Lu, Allen, TX (US); Yi Wang, San Jose, CA (US); Zheng Qi, Cupertino, CA (US); Shivaji Roy, Gilbert, AZ (US)

(72) Inventors: Yang Lu, Allen, TX (US); Yi Wang, San Jose, CA (US); Zheng Qi, Cupertino, CA (US); Shivaji Roy, Gilbert, AZ (US)

(21) Appl. No.: 19/433,546

(22) Filed: Dec. 26, 2025

Related U.S. Application Data
(60) Provisional application No. 63/869,598, filed on Aug. 25, 2025.

(51) Int. Cl. G06F 11/34; G06F 9/48; G06F 11/30; G06F 11/32

(52) U.S. Cl. CPC G06F 11/3457; G06F 9/4881; G06F 11/3062; G06F 11/323

(57) ABSTRACT

An event-based simulator enables designers and developers to optimize performance and power for neural network model execution on accelerators and full-stack computing systems. The simulator decomposes neural network models into tasks, simulates dispatch, completion, and dependencies using task queues, and advances simulation time according to predetermined task durations. Events recorded during simulation provide performance statistics and metrics, while activity factor sampling estimates power consumption. Extending simulation to the entire system stack allows end-to-end analysis of deep neural network execution in multi-threaded environments with multiple pipelines and varying quality-of-service levels for different models. Performance metrics such as latency, throughput, deadline-miss rate, and utilization are derived from event data points collected across different system stack levels.

### PRIORITY APPLICATION

This patent application claims priority to and/or receives benefit from U.S. Provisional Application No. 63/869,598, filed on 25 Aug. 2025, titled “JOINT PERFORMANCE-POWER OPTIMIZATION FRAMEWORK FOR NEURAL PROCESSING UNIT BASED ARTIFICIAL INTELLIGENCE INFERENCE” (Docket No. AG7284-Z). The US Provisional Application is hereby incorporated by reference in its entirety.

### BACKGROUND

The last decade has witnessed a rapid rise in artificial intelligence (AI) and machine learning (ML) based data processing, particularly based on neural networks (also referred to as “deep neural networks” or “DNNs”). DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution, matrix multiplication, layer normalization, batch normalization, SoftMax operation, pooling, element-wise operation, linear operation, non-linear operation, and so on.

Deep neural network (DNN) accelerators are specialized hardware platforms designed to efficiently execute the computationally intensive operations of DNNs. These accelerators can include arrays of processing elements optimized for parallel multiply-and-accumulate (MAC) operations, local memory for storing activations and weights, and high-bandwidth data paths to facilitate rapid movement of tensors within the device. DNN accelerators achieve significant improvements in throughput and energy efficiency compared to general-purpose central processing units (CPUs) and graphics processing units (GPU). DNN accelerators are widely deployed in applications ranging from cloud datacenters to mobile and edge devices, enabling real-time inference and training for tasks in computer vision, speech recognition, and natural language processing.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a joint performance-power optimization framework, according to some embodiments of the disclosure.

FIG. 2 illustrates modeling performance of a DNN accelerator at a task-level, according to some embodiment of the disclosure.

FIG. 3 illustrates modeling power consumption of a DNN accelerator using power nodes, according to some embodiments of the disclosure.

FIG. 4 illustrates a power trace, according to some embodiments of the disclosure.

FIG. 5 illustrates an end-to-end model of a computing system having a host processor and a DNN accelerator, according to some embodiments of the disclosure.

FIG. 6 illustrates a process for joint performance-power end-to-end modeling of execution of one or more pipelines on a computing system, according to some embodiments of the disclosure.

FIG. 7 illustrates a visualization of task execution over simulation time for a plurality of pipelines and processes, according to some embodiments of the disclosure.

FIG. 8 is a flow diagram illustrating a method for simulating an execution of a neural network model, according to some embodiments of the disclosure.

FIG. 9 is a flow diagram illustrating a method for simulating an execution of a neural network model, according to some embodiments of the disclosure.

FIG. 10 depicts a block diagram of an exemplary computing device, according to some embodiments of the disclosure.

### DETAILED DESCRIPTION

### Challenges in Effective Optimizations for Deploying DNN Models on Systems Having DNN Accelerators

The explosion of generative AI/ML has driven rapid deployment of AI/ML features across many applications, with AI/ML compute capabilities increasingly integrated into client devices to support scalable model inference processing. As DNN models become larger and more complex, inference becomes both computationally intensive and power-consuming, creating significant optimization challenges for client device deployment. DNN accelerators can offer specialized solutions by offloading entire DNN model inference as computational/processing graphs onto purpose-built acceleration hardware. To achieve high efficiency, DNN accelerator solutions can rely on graph compilers to optimize AI/ML models and specialized driver stacks to manage job submission latency. DNN accelerators can integrate embedded processors and dedicated firmware to manage task scheduling within computational/processing graphs and coordinate with host drivers and applications. DNN accelerators can be integrated into a System-on-Chip (SoC) with other processing components and circuits.

Many AI/ML applications present unprecedented complexity that extends far beyond individual operator optimization. While optimizing specific compute tasks on specialized hardware (such as convolution or matrix multiplication on dedicated arrays) remains important, AI/ML inference performance ultimately experienced by applications results from complex interactions across the entire software-hardware stack, including host drivers, graph compilers, and DNN accelerator firmware.

Contemporary generative AI/ML inference use cases usually demand multi-modal processing and complex application-level pipelines. End-to-end application performance reflects multiple AI/ML models interacting within predefined processing pipelines. Real-time inference requirements can necessitate high-priority quality-of-service (QOS) support and preemption capabilities for previously submitted DNN accelerator tasks. This preemption becomes a critical performance factor that cannot be captured through traditional operator-level or single-model analysis approaches.

The complexity of modern AI/ML use cases thus demands systematic joint optimization of hardware and software components. Other approaches that optimize hardware and software components in isolation fail to capture the interdependencies that dominate real-world DNN accelerator performance. Some development and optimization approaches suffer from several critical limitations because they lack of end-to-end analysis and optimization capability. For example, existing hardware design simulators written in traditional simulation languages such as SystemC and SystemVerilog typically focus on cycle-accurate RTL (Register-Transfer Level) pipeline and bus protocol modeling. These simulators are fundamentally too slow for AI/ML workload analysis. Simulating a single AI/ML operator can take hours or days, making full model or use case simulation practically impossible within reasonable timeframes. In another example, some hardware simulators typically operate at instruction or operator levels and cannot scale to simulate complete AI/ML use cases involving multiple models, complex pipelines, and real-world scheduling scenarios. Such simulators can often take weeks or months to perform a simulation. In yet another example, system designers can perform performance and power analysis separately, often using Excel-based approaches that cannot capture the complex interdependencies between hardware capabilities, software scheduling, power states, and use case requirements. Ability to perform end-to-end use case optimizations can be beneficial for designers and developers, because an end-to-end view of the whole computing system having hardware and software components means that the designers and developers can consider the various aspects of the computing system including firmware scheduling, driver efficiency, compiler optimizations, and hardware resource allocation all working together.

For client devices such as personal computers, tablets, and mobile devices, power consumption represents a fundamental constraint on AI/ML inference deployment. Client devices face dual limitations: thermal constraints from sustained processing and battery life requirements for portable operation. It is desirable for DNN accelerator inference solutions to achieve maximum power efficiency while maintaining sufficient performance to satisfy user experience requirements.

Sustainable AI/ML performance on client devices can involve intelligent power management that goes beyond peak performance optimization. Power management techniques can includes dynamic voltage and frequency scaling, power state management, and workload scheduling that considers both performance targets and power budgets. The challenge lies in joint optimization of performance and power consumption driven by real-world AI/ML workloads and use case scenarios.

Comprehensive analysis reveals no existing joint performance-power simulation framework designed specifically for DNN accelerators. Available approaches fall into three inadequate categories: (1) functional-only simulators (e.g., Simics, Fast Models), (2) traditional CPU/GPU hardware simulators (e.g., gem5, GPGPU-Sim), and (3) academic DNN accelerator component simulators (e.g., SCALE-Sim, Timeloop). For category 1, these platforms focus on functional correctness without performance or power modeling capabilities for AI/ML accelerators. Developers discover performance bottlenecks after complete functional validation, leading to costly redesign cycles before silicon tape-out. For category 2, instruction-level simulators designed for general-purpose processors cannot scale to simulate complete AI/ML models or system-level use cases. While suitable for optimizing individual kernels, they lack the abstraction level needed for AI/ML workload scheduling, layer fusion, and multi-engine coordination optimization. For category 3, research tools focus narrowly on operator-level analysis of MAC arrays and convolution engines. They cannot address full model inference, multi-model pipelines, or system-level factors like memory bandwidth, firmware scheduling, and cross-engine workload pipelining that dominate real-world DNN accelerator performance.

a Joint Performance-Power Optimization Framework that Includes Efficient Simulation of One or More DNN Model Executions on Target Hardware

One or more of the challenges discussed above can be addressed by implementing a comprehensive and computationally efficient simulation system that can model DNN model execution on target hardware. Performance and power can be optimized by running simulations under different constraints and parameters. The resulting system offers a framework and platform for joint performance and power optimization of DNN model execution on various computing systems. More specifically, the framework and platform can enable joint performance and power optimization for DNN accelerator-based AI/ML inference at the use case level by leveraging a comprehensive, accurate, and effective simulation framework.

An event-based simulator enables designers and developers to optimize performance and power for neural network model execution on accelerators and full-stack computing systems. The simulator decomposes neural network models into tasks, simulates dispatch, completion, and dependencies using task queues, and advances simulation time according to predetermined task durations. Events recorded during simulation provide performance statistics and metrics, while activity factor sampling estimates power consumption. Extending simulation to the entire system stack allows end-to-end analysis of deep neural network execution in multi-threaded environments with multiple pipelines and varying quality-of-service levels for different models. Performance metrics such as latency, throughput, deadline-miss rate, and utilization are derived from event data points collected across different system stack levels.

According to one aspect of the solution, a high-speed event-driven DNN accelerator system simulator is implemented. The simulator can be referred to herein as an event-based DNN execution simulator. The simulator can include a Python-based framework that can achieve orders-of-magnitude simulation speedup when simulating complete DNN accelerator subsystems with multiple heterogeneous computing tiles and parallel engines when compared to simulation of models using hardware cycle-based or transaction-based simulators. The event-based DNN execution simulator can produce a foundational performance simulation by modeling a DNN model as a set of tasks and task dependencies and modeling the interactions of critical DNN accelerator (hardware, software, or firmware) components as coordinated hardware events through an advanced event simulator. The event simulator can simulate concurrent component operation while enabling tracking and analyzing performance statistics including pipeline delay, memory access latency, bandwidth utilization, and computation time.

According to another aspect of the solution, the event-based DNN execution simulator incorporates comprehensive modeling of dynamic power consumption for hardware components and circuits by modeling them as power nodes. Utilizing pre-characterized dynamic capacitance (Cdyn) values for maximum power consumption modeling, the simulator enables recording of transitory power consumption data points at configurable intervals based on utilization-based activity factors. Power calculation can take into account of clock domains, voltage domains, and device power states. Incorporating effective power consumption modeling means that joint optimization performance and power is possible through this unified framework.

According to another aspect of the solution, the event-based DNN execution simulator can be extended to support end-to-end use case analysis and pipeline modeling to support concurrent pipelines with QoS and preemption modeling to enable hardware-software co-optimization. The end-to-end modeling can include full software stack support, multi-model, multi-tile, multi-context, and multi-pipeline concurrency, QoS and preemption management, and dynamic power management. The end-to-end modeling can include built-in capabilities for simulating multiple concurrent software pipelines and inference preemption based on QoS priority, with well-defined cost models for simulating software component interactions across the entire software stack.

The framework can facilitate systematic optimization at the platform and application use case level, eliminating ad-hoc analysis approaches and enabling true hardware-software co-optimization.

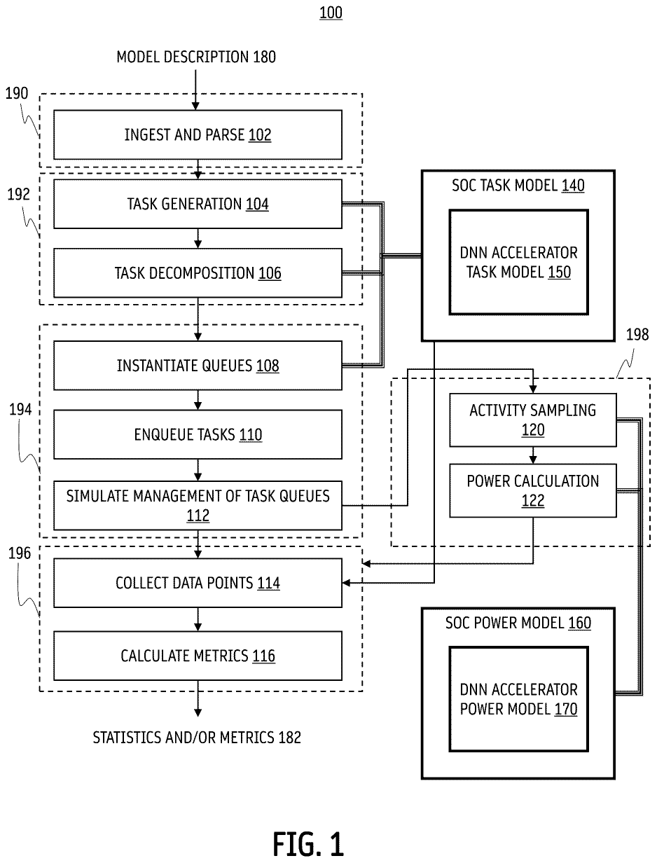

FIGS. 1-9 and the disclosure herein illustrate a system-oriented, event-driven DNN accelerator modeling methodology and a comprehensive tool flow capable of modeling end-to-end DNN accelerator model execution performance. The solution can support complete model inference through parallel task execution across multiple heterogeneous hardware engines, AI/ML model computation graph optimization via graph compilers, complete use case pipeline scheduling and job submission, and dynamic device power profiling and management at both fine-grain component and full use case levels.

### Additional Technical Advantages and Improvements Over the State of the Art Techniques

In some implementations, the framework enables multi-level DNN accelerator optimizations, including optimization at the DNN model level or even at the layer level of a DNN model, the use case level, the compiler level (by changing the way the DNN model is compiled), at the task-level (by changing the way how a processing graph is decomposed into workloads), at the pipeline scheduling level (by varying pipeline configurations)

In some implementations, the framework incorporates a power model to model/simulate device power state management and power state transition impact (e.g., through latencies), and power nodes to model/simulate hardware activity impact simulation on peak power at module/block level based on use case workload processing patterns observed in the simulation.

In some implementations, the framework is agnostic to the type of graph compiler that is used for compiling DNN models for execution. Moreover, the framework provides a way to compare and correlate performance and capabilities of graph compilers under a variety of different operating conditions (e.g., profiling across different DNN models and use cases), e.g., during early-stage compiler optimizations.

In some implementations, the event data points collected through past simulation(s) can be stored and replayed at a later point in time to rapidly reconstruct full use cases to achieve approximately 50× simulation time reduction with less than 1% accuracy tolerance.

In some implementations, the framework enables end-to-end software/hardware co-optimization of DNN accelerator solutions during early product development stages through comprehensive what-if analysis of cost structure impacts and software task hardware offloading evaluation.

In some implementations, the collected event data points and performance metrics provide detailed reporting and tracing capabilities at the system, block, module, and circuit levels of the DNN accelerator, facilitating system-level performance tuning through enhanced visibility and predictability of platform performance characteristics.

### Event-Based Modeling

Before diving into the event-based DNN execution simulator, the following describes event modeling performance of a system and simulating a system using an event-based or event-driven model involving tasks and task queues.

An event simulator utilizing tasks and task queues involves simulating managing and updating states of task queues and recording timing of events. The event simulator operates by generating tasks that correspond to units of work or activity within a modeled system. These tasks are placed into one or more task queues, which serve as organizational structures for pending work. The simulator processes tasks by dispatching them from the queues according to one or more predefined rules or scheduling policies. As tasks are dispatched and completed, the simulator records the timing of relevant event data points, such as task start and completion times. The progression of simulated time is governed by the occurrence of events and set/predetermined/measured duration of the tasks, allowing the simulator to model temporal relationships and dependencies among tasks. The simulator thus enables task-level analysis of system behavior, resource utilization, and performance characteristics in a controlled, repeatable environment.

Suppose the event simulator models how a computer system processes jobs. Each job is a task, for example, a calculation or a data transfer. The simulator can create a task queue to hold these jobs. As the simulation runs, tasks are added to the queue whenever new jobs arrive. The simulator advances simulated time as jobs are dequeued and checks the queue. If resources (like a processor or memory channel) are available, the simulator removes/dequeues a task from the queue and simulates its execution by advancing the simulation time by the expected duration to perform the task. The simulator can record the event times, such as when each task starts and when it finishes. If the system is busy, tasks wait in the queue until resources are free. By tracking the event times, the simulator can analyze how long tasks wait, how quickly they are processed, and how system performance changes under different conditions. The simulator thus helps to identify bottlenecks and allows for iterative changes to be simulated and evaluated before building the system.

### Event-Based DNN Execution Simulation

It is not trivial to build an event-based DNN execution simulator. Several technical tasks can be involved. The event-based DNN execution simulator relies on using set/measured/predetermined durations associated with the performance of tasks and/or occurrences of certain events to advance a simulation time. Also, the event-based DNN execution simulator may need to implement processes for coordinating parallel task execution across different hardware blocks while preserving each block's pipeline behaviors and shared resources. Moreover, it is not trivial to select the appropriate granularity and level of abstraction to accurately model the durations of timing-critical/dominant phenomena while allowing the simulator to run in hours instead of weeks. In addition, the event-based DNN execution simulator may need to implement processes to advance simulation time while respecting barriers and task dependencies that may impact the progression of the simulation.

Tackling these technical tasks, the event-based DNN execution simulator described and illustrated herein strategically identifies and characterizes (hierarchically) a DNN hardware accelerator as a set of hardware/software components and blocks. In addition, the simulator models operations and interactions of the hardware/software components/blocks of a DNN hardware accelerator using task queues and predefined durations associated with performance impacting events. An event simulator can manage the task queues and advance the simulation time according to the predefined durations as the performance impacting events occur. The hardware/software components/blocks may monitor relevant events to create one or more new tasks to be enqueued and emit an event upon completion of a task. The components/blocks can create a chain reaction or simulated process, where the components/blocks create tasks in response to events, and then generate new events for others upon completion of tasks.

Unlike other hardware simulators that focus on simulating the cycle-level behavior of the hardware logic, the event-based DNN execution simulator is designed to capture high-level performance impacting events and statistics. Events may be defined with appropriate granularity to capture the key performance metrics of DNN accelerator processing with representative hardware characteristics. Yet it can achieve a reasonable simulation speed even for large AI/ML models. For example, on a typical cycle-based or cycle approximate hardware simulator, one AI/ML operator for a single layer can take several hours or days to simulate. The event-based DNN hardware accelerator can simulate a large AI/ML model with hundreds or thousands of layers in a few hours.

Events driving the simulator can be at different granularity levels. Not all events represent the same size or type of activity. Some events are “coarse-grained” (big-picture), such as starting or finishing an entire AI model inference. Others are “fine-grained” (detailed), such as moving a small block of data, dequeuing a task, checking a barrier, or completing a single task in a pipeline. The simulator uses events at various levels of detail to balance simulation speed and accuracy. Examples of events may include enqueueing of a task, or a memory access request, or starting a pipelined computation operation of a large data block, etc.

FIG. 1 illustrates joint performance-power optimization framework 100, according to some embodiments of the disclosure. Framework 100 can include model analyzer 190, task generator 192, event-based DNN execution simulator 194, and statistics and metrics collection 196.

Model analyzer 190 may receive model description 180. Model description 180 may include a description of a neural network model. Model description 180 can include one or more of: a model definition, an intermediate representation, and a compiled binary representation. A model definition is a high-level description of a neural network or computational model, typically specifying the structure, layers, operations, and data flow. The model definition may be written in a framework-specific format (such as TensorFlow, PyTorch, or Open Neural Network Exchange (ONNX). An intermediate representation is a platform-agnostic or standardized form of the model that abstracts away framework-specific details. The intermediate representation may reorganize, optimize, or normalize the model computational/processing graph to facilitate analysis, simulation, or deployment on diverse hardware or software backends. A compiled binary representation is a low-level, executable format of the model produced after compilation. The compiled binary representation is tailored for a specific hardware target or runtime environment and has all necessary instructions and parameters for direct execution, often enabling higher performance and efficiency.

In some embodiments, model description 180 may be defined according to one or more of the following formats: ONNX Runtime format DirectX12 format, Neural Network Exchange Format (NNEF) format, Predictive Model Markup Language (PMML) format, Portable Format for Analytics (PFA) format, TensorFlow SavedModel (SavedModel) format, TensorFlow Checkpoint (Checkpoint) format, Keras Model (Keras) format, TensorFlow Lite (TFLite) format, PyTorch TorchScript (TorchScript) format, PyTorch FX Graph (FX Graph) format, Model Archive for TorchServe (MAR) format, Safe Tensors (safetensors) format, General Graph Model Library (GGML) format, General Graph Unified Format (GGUF) format, Core ML Model (Core ML) format, OpenVINO Intermediate Representation (OpenVINO IR) format, TensorRT Engine (TensorRT) format, Snapdragon Neural Processing Engine DLC (SNPE DLC) format, nonn Model (ncnn) format, Mobile Neural Network (MNN) format, Tencent Neural Network (TNN) format, Tengine Model File (tmfile) format, Stable High-Level Operations (StableHLO) format, MLIR High-Level Operations (MHLO) format, Multi-Level Intermediate Representation (MLIR) format, TVM Relay Intermediate Representation (TVM Relay) format, IREE Virtual Machine Flatbuffer (IREE VMFB) format, MXNet Model (MXNet) format, PaddlePaddle Model (PaddlePaddle) format, MindSpore MindIR (MindIR) format, Microsoft Cognitive Toolkit (CNTK) format, Caffe Model (Caffe) format, Darknet YOLO Model (Darknet) format, NumPy Array (NumPy) format, Hierarchical Data Format (HDF5) format, and Python Pickle (Pickle) format.Model analyzer 190 may include ingest and parse operation 102. In some embodiments, ingest and parse operation 102 can include parsing model inputs, validating graph consistency, and annotating operator metadata. In some embodiments, ingest and parse operation 102 include extracting information/characteristics/parameters about the various operations/nodes in the processing/computational graph and connections/edges connecting the operations/nodes.

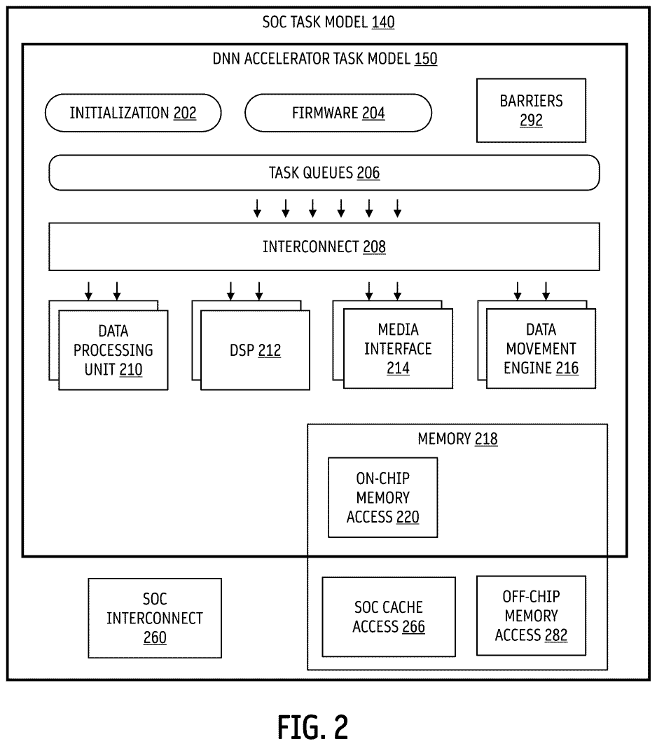

Task generator 192 is responsible for creating tasks that can be used in the event-based model. The tasks that task generator 192 creates are guided by SoC task model 140 and DNN accelerator task model 150 (as denoted by the lines connecting SoC task model 140 and DNN accelerator task model 150 to operations in task generator 192). Specifically, task generator 192 decomposes the neural network model into one or more tasks based on model description 180. SoC task model 140 and DNN accelerator task model 150 are described and illustrated in FIG. 2. SoC task model 140 and DNN accelerator task model 150 models the DNN accelerator hardware as a hierarchy of components/blocks interacting with each other through task queues. The components/blocks can have specific capabilities and interfaces. Task generator 192 takes model operations extracted by model analyzer 190 to map the operations to the appropriate component/block.

For event-based DNN execution simulator 194, tasks are units of work that drive the occurrences of events as tasks are enqueued and dequeued during simulation. The tasks and occurrences of events allow performance to be modeled. At a high-level, the operations in a compiled AI/ML model (e.g., extracted from model description 180) may be converted into a set of tasks or task data objects and distributed by a scheduler into different components/blocks of the SoC task model 140 and DNN accelerator task model 150. The enqueuing and completion of the tasks can become the high-level events tracked by the event-based DNN execution accelerator. Task start time and completion time may be gathered and task-level statistics may be collected. Task start and completion events may also be tracked based on barrier-related events governing task-level synchronization.

Task generator 192 can include task generation operation 104. Task generation operation 104 can map one or more neural network operations in model description 180 to one or more task types. The one or more task types include one or more of: a memory transfer task, a compute task, and a control task.

Task generator 192 can include task decomposition operation 106 can include partitioning tasks using accelerator-aware parameters such as tiling, stencil, loop-unrolling, data widths, and memory capacities to align with DNN accelerator capabilities. Task decomposition operation 106 can split large tasks into data block events suited for concurrent execution and accurate timing.

In some embodiments, task decomposition operation 106 can decompose one or more neural network operations in the description into the one or more tasks based on one or more hardware configurations of the neural network accelerator. The one or more hardware configurations include one or more of: a tiling parameter, a stencil configuration, a data width of a digital signal processor of the neural network accelerator, a loop-unrolling factor, a memory capacity, and a width of a memory data path. Decomposing neural network operations into tasks based on hardware configurations, such as tiling parameters, stencil configurations, processor data width, loop-unrolling factors, memory capacity, and memory data path width, can align the tasks with the specific capabilities and constraints of the hardware. The events being tracked by event-based DNN execution simulator 194 can be more accurate in modeling parallelism and use of memory and compute resources.

A memory transfer task can handle the movement of data between different memory locations or hardware blocks. A memory transfer task can include a source location, a destination location, and a size of the transfer. A memory transfer task can include reading from or writing to memory and transferring data across channels. The memory transfer task can model the effect of channel or port bandwidth arbitration, memory bandwidth, and transfer latency. The memory transfer task may be further divided into smaller memory transfer tasks of smaller sizes to accurately simulate concurrent data movement and resource contention. In some contexts, a memory transfer task may be referred to data movement task or direct memory access task. When processing a memory transfer task, a data movement engine can further divide the task into a set of memory transfers of certain size. In order to model the effect of channel/port bandwidth (BW) arbitration, memory BW and latency, the data movement task may be decomposed in task decomposition operation 106 into smaller memory transfer tasks of a certain size to model each channel as separate event processing threads with designated transfer queues to achieve modeling level concurrency.

A compute task is responsible for performing calculations or data processing operations. In the context of a DNN accelerator, a compute task may include tasks such as running arithmetic operations, executing neural network layers, or processing data blocks through specialized hardware units like digital signal processors (DSPs), vector processors, data processing units (DPUs), a processing array, a post-processing circuit, etc. The compute task can be broken down into smaller blocks based on factors like single instruction multiple data (SIMD) width or loop-unrolling and may be modeled as a pipeline with stages for loading, computing, and storing results. The compute task can correspond to a workload executable by one of: a data processing unit of the neural network accelerator, a processing array of the neural network accelerator, a post-processing circuit of the neural network accelerator, and a digital signal processor of the neural network accelerator. For a compute task targeted for a vector processor, the compute task may be decomposed into multiple tasks in task decomposition operation 106 based on SIMD width and loop-unrolling count. For a compute task targeted for a vector processor or digital signal processor, the compute task may be decomposed into multiple tasks in task decomposition operation 106 to treat load/compute/store pipeline stages as threads and track the load/compute/store of the data blocks of the tasks as events. Decomposing a compute task's pipeline stages in task decomposition operation 106 can abstract the processor load/compute/store pipeline from instruction-level to a data block level. For a compute task targeted for a data processing unit or a processing array, the compute task may be decomposed into multiple tasks based on the stencil configuration of the compute array (e.g., a multiply-and-accumulate array). The compute task may be decomposed into multiple tasks in task decomposition operation 106 to treat load/MAC array compute/post-processing compute/store pipeline stages as threads and track the data blocks of the tasks flowing through the pipeline as events

A control task manages the coordination and synchronization of other tasks within the system. Control tasks may include activities like scheduling task execution, handling synchronization barriers, managing dependencies between tasks, or orchestrating the flow of data and operations across different components/blocks. Control tasks ensure that tasks are executed in the correct order in event-based DNN execution simulator 194 and that resources are allocated efficiently according to system policies and dependencies. In some embodiments, a control task corresponds to a barrier having one or more producer tasks and one or more consumer tasks. The control task may correspond to tasks involved with managing the barrier, such as programming the barrier, checking the barrier, managing synchronization behavior associated with the barrier, signaling that producer tasks are completed and consumer tasks can start, etc.

Event-based DNN execution simulator 194 can include instantiate queues operation 108, enqueue tasks operation 110 and simulate management of task queues operation 112.

Instantiate queues operation 108 can include creating and instantiating task queues. One or more task queues can be instantiated for each component/block in SoC task model 140 and DNN accelerator task model 150. In some embodiments, instantiate queues operation 108 comprises setting up the data structures that will hold and organize tasks before the tasks are dispatched or dequeued during the simulation. During initialization, instantiate queues operation 108 may include defining a capacity and ordering rules (such as first-in-first-out (FIFO) FIFO or priority-based) of a queue, based on hardware configuration parameters such as tiling, data width, and memory limits of the corresponding component/block in SoC task model 140 and DNN accelerator task model 150. Initializing appropriate task queues for the component/block in the SoC task model 140 and DNN accelerator task model 150 can ensure that the component/block receives tasks in a controlled, synchronized manner, enabling efficient scheduling, parallelism, and resource management throughout the simulation.

Enqueue tasks operation 110 can enqueue the one or more tasks from task generator 192 into one or more task queues instantiated in instantiate queues operation 108. In some embodiments, enqueue tasks operation 110 can include populating a task queue with initial tasks generated from the parsed neural network model according to hardware configuration parameters.

Simulate management of task queues operation 112 can include running event-based DNN execution simulator 194. Running event-based DNN execution simulator 194 can include simulating dispatch and completion of the one or more tasks in the one or more task queues according to one or more of task dependency and resource availability. Simulating dispatch and completion of tasks in task queues according to task dependency and resource availability means that event-based DNN execution simulator 194 models how tasks are selected/popped from the task queue and assigned to components/blocks of SoC task model 140 and DNN accelerator task model 150 when certain conditions are met. For example, a task can be dispatched if its dependencies, such as required input data, completion of preceding tasks, or barrier synchronization, are satisfied, and if the necessary hardware resources (e.g., compute engines, memory bandwidth, or data movement channels) are available and not occupied by other tasks.

Simulate management of task queues operation 112 can involve event-based DNN execution simulator 194 advancing a simulation time according to one or more durations corresponding to the one or more tasks. Simulate management of task queues operation 112 can involve event-based DNN execution simulator 194 advancing or updating one or more states of the one or more task queues according to the dispatch and the completion of the one or more tasks. Simulate management of task queues operation 112 can involve event-based DNN execution simulator 194 advancing or updating one or more states of the one or more task queues according to firmware-like policies such as round-robin, first-come-first-served. Simulate management of task queues operation 112 can involve event-based DNN execution simulator 194 advancing or updating one or more states of the one or more task queues according to task dependencies and barrier synchronization rules.

The one or more durations used to advance the simulation time can be retrieved from a data store having one or more profiled durations measured from executing the one or more tasks on a neural network accelerator. In some embodiments, the durations, such as the time for task execution, pipeline stages, and barrier-related events can be profiled from past executions of tasks on a neural network accelerator. The one or more durations can be managed and maintained using one or more configuration files that define cost tables for various tasks being completed by different components/blocks of SoC task model 140 and DNN accelerator task model 150. The configuration files, often in formats like JavaScript Object Notation (JSON) or YAML Ain′t Markup Language (YAML), specify values such as task latency, pipeline delays, barrier wait times, and firmware scheduling overheads, either as fixed numbers or as entries measured from silicon or prior simulations. During simulation, simulate management of task queues operation 112 involves reading these duration values from the configuration files and uses them to model how long each task (or event) should take and advances the simulation time accordingly. The one or more durations allows event-based DNN execution simulator 194 to accurately model the timing behavior and ensure that the simulation reflects realistic hardware and firmware performance. Utilizing configuration files has the added benefit to allow users to easily adjust, calibrate, or inject new timing profiles for different hardware configurations or optimization scenarios, making the simulation both flexible and accurate.

As the simulation progresses, dispatching of a task can be tracked as an event where the task start time may be recorded. The theoretical completion of the event (e.g., advancing of the simulation time) can be tracked as an event where the task complete time may be recorded. The completion of a task in the simulation may trigger one or more new tasks. The completion of a task in the simulation may release resources. The completion of a task in the simulation may enable dependent tasks to proceed. This simulation thus accurately reflects real-world scheduling, where both logical dependencies and physical resource constraints govern the flow and timing of computation.

Statistics and metrics collection 196 can include collect data points operation 114. Collect data points operation 114 can include recording information about events during the simulation. As tasks are dispatched and completed, collect data points operation 114 can log data such as timestamps (start and finish times) based on the simulation time. In some embodiments, collect data points operation 114 involves collecting one or more event data points for the one or more tasks based on the simulation time and one or more states of the one or more task queues. The one or more event data points include one or more of: one or more task start times and one or more task completion times associated with the one or more tasks. In some embodiments, the one or more event data points include one or more of: a time when a task is enqueued and a time when the task is dequeued. During simulation, collect data points operation 114 may include recording when specific events occur, such as dispatch, start, and completion, all referenced to the simulation time. In some cases, the event data points can include information such as the current state of the task queues, capturing information like queue length, task order, and resource availability at each event. By gathering event data points, raw data can be captured to reveal performance of the DNN model execution. In some cases, collect data points operation 114 may include recording when specific events occur, such as events relating to barrier synchronization, firmware operations, and initialization processes.

Statistics and metrics collection 196 can include calculate metrics operation 116. Calculate metrics operation 116 includes calculating one or more performance metrics based on the one or more event data points. Calculate metrics operation 116 can aggregate the one or more event data points to produce statistics and/or metrics 182, such as latency, throughput, resource utilization, number of completed tasks, for optimization and validation. Statistics and/or metrics 182 provide insights into system performance, bottlenecks, and efficiency.

Statistics and metrics collection 196 can emit traces visualizing the one or more of: event data points, statistics, and metrics. Traces are visual representations or logs that can show the timing and sequence of event data points (such as when tasks are dispatched, started, or completed), as well as aggregate statistics like average latency, throughput, and resource utilization. These traces and metrics help visualize how tasks move through the system, identify bottlenecks, and understand the impact of hardware and scheduling decisions.

By collecting and outputting both granular event data and high-level performance summaries, joint performance-power optimization framework 100 enables thorough analysis and optimization of neural network accelerator behavior.

FIG. 2 illustrates modeling performance of a DNN accelerator at a task-level, according to some embodiment of the disclosure. A design hierarchy of the DNN accelerator on a SoC can be fully modeled with representative components/blocks.

The simulation models the operation of DNN accelerator using DNN accelerator task model 150. DNN accelerator task model 150 represents the simulation abstraction for the neural network accelerator, encapsulating both control and data flow components. DNN accelerator task model 150 can include one or more components/blocks, including one or more of: initialization 202, firmware 204, task queues 206, interconnect 208, one or more instances of data processing unit 210, one or more instances of DSP 212, one or more instances of media interface 214, one or more instances of data movement engine 216, barriers 292, and on-chip memory access 220.

Task queues 206 represents the central mechanism for managing and organizing tasks as they move through the DNN accelerator. Task queues 206 may hold pending tasks generated by initialization 202 and firmware 204 and ensure that each task is dispatched to the appropriate component/block, e.g., data processing unit 210, DSP 212, media interface 214, or data movement engine 216, when dependencies are satisfied and resources are available. Task queues 206 enable parallelism by allowing multiple tasks to be tracked and scheduled simultaneously, and they facilitate synchronization by coordinating with barriers 292. By modeling task queues 206, DNN accelerator task model 150 can accurately represent real-world scheduling, resource allocation, and execution order, to simulate performance, latency, and throughput in the DNN accelerator.

One or more of the components/blocks, such as data processing unit 210, DSP 212, interconnect 208, media interface 214, and data movement engine 216, can also have their own internal task queues. These internal task queues can manage tasks assigned to each component/block to track their progress through pipeline stages, and handle resource contention/allocation within the component/block, or parallel execution within the component/block.

While task queues 206 serve as the central coordination point, holding tasks before they are dispatched to the appropriate component/block, once a task is dispatched, the task may enter an internal queue of the component/block, where the task waits for execution based on the availability, pipeline depth, or scheduling logic of the component/block. For example, data movement engine 216 might have separate queues for different data movement channels, and DSP 212 could maintain queues for pipelined SIMD operations.

This hierarchical queuing structure, i.e., having task queues 206 for system-wide scheduling and local queues within components/blocks for fine-grained execution, can enable accurate modeling of both global and local resource management, parallelism, and synchronization in the DNN accelerator. In some embodiments, the component/block may include multiple local queues representing multiple threads. The component/block may include pipeline stages for task competition. The component/block may include one or more event FIFOs.

Initialization 202 can include one or routines for setting up simulation parameters, allocating resources, and preparing task queues for execution. Initialization 202 can ensure that all hardware and software modules are correctly configured before simulation begins. Initialization 202 may have associated tasks, and the tasks may have associated durations to model the performance of initialization 202.

Firmware 204 can include logic for job scheduling, task generation, and coordination of components/blocks. Firmware 204 can run control Reduced Instruction Set Computing-V (RISC-V) logic. Firmware 204 can manage dependencies using barriers 292, submit tasks, trigger task dispatch from task queues 206, and handle completion signals for barriers 292, reflecting real-world accelerator firmware behavior. Firmware 204 may have associated tasks, and the tasks may have associated durations to model the performance of firmware 204.

Barriers 292 can include synchronization primitives that enforce dependencies between tasks, ensuring correct execution order and resource sharing. Barriers 292 can be used to model hardware-level or software-level synchronization events. Barriers 292 are modeled in terms of cost by assigning a specific latency or overhead value to each barrier synchronization event within the simulation framework. The costs can be defined in configuration files or cost tables, which specify how much time is added when a task or group of tasks waits for a barrier to be lifted before proceeding. The cost can reflect hardware-level delays (such as waiting for all dependent tasks to complete) or firmware/software overheads (such as managing synchronization logic). These values are often measured from silicon or estimated based on empirical data and can be injected statically or dynamically during simulation. By modeling barrier costs explicitly, the simulator can accurately account for the impact of synchronization on overall latency, throughput, and resource utilization, helping to identify bottlenecks and optimize scheduling strategies.

Interconnect 208 can include communication pathways, such as a spine Network-on-Chip, for transferring data and control signals between data processing unit 210, DSP 212, media interface 214, data movement engine 216, etc. Interconnect 208 can model bandwidth, latency, and arbitration effects in the accelerator. In some embodiments, interconnect 208 can include parameters for bandwidth, latency, and contention, allowing the simulator to capture how data moves between modules and how bottlenecks or delays can arise when multiple tasks compete for access. Specifically, interconnect 208 can have tasks that have associated costs or durations specified in configuration files or cost tables. The costs or durations can include one or more of transfer rates, arbitration policies, and pipeline depths. When a task requires data movement across interconnect 208, the simulator can check the availability of interconnect 208 and apply modeled delays or bandwidth limits to record the time taken for data to traverse interconnect 208. In some embodiments, interconnect 208 can also model priority schemes, multi-channel routing, and congestion effects, reflecting real-world hardware behavior. Ability to model interconnect 208 can be particularly beneficial for simulating complex AI workloads, since the workloads typically involve a significant amount of data movement.

Data processing unit 210 can include compute engines for executing neural network operations, such as matrix multiplications or convolutions. DSP 212 can include digital signal processors optimized for vector and signal processing tasks. Media interface 214 can include modules for handling input/output with external devices or subsystems. Data movement engine 216 can include direct memory access (DMA) controllers or other hardware for efficient data transfer between memory and compute units. These components/blocks may have associated tasks, and the tasks may have associated durations to model the performance of tasks being completed using these component/blocks.

Memory 218 comprises one or more of: on-chip memory access 220, off-chip memory access 282, and SoC cache access 266. Memory 218 can include one or more blocks to model access to storage resources, where different data accesses have corresponding access characteristics, capacity, and bandwidth constraints, which can translate to appropriate durations that can be used to advance the simulation time during the simulation. SoC task model 140 and DNN accelerator task model 150 models memory accesses as part of the overall system hierarchy, allowing memory access tasks to be simulated.

On-chip memory access 220 can model fast memory access to on-chip memory resources such as static random access memory (SRAM). On-chip memory resources provide temporary storage for intermediate data, weights, and activations during neural network computation. In the simulation, data from on-chip memory resources can be accessed by compute engines such as data processing unit 210 and DSP 212, with constraints on capacity and bandwidth. The simulation can log data is loaded into and out on-chip memory access 220 and how contention or limited space of the on-chip memory resources can affect task scheduling and performance. Individual data movement or transfer tasks may have associated durations (e.g., durations calculated based on the constraints of on-chip memory access 220) to model the performance of data movement or transfer task being completed by on-chip memory access 220.

Off-chip memory access 282 can include model access to off-chip memory resources or system memory such as external dynamic random-access memory (DRAM). Off-chip memory resources provide larger capacity but higher latency storage for storing large datasets, model parameters, and input/output buffers that exceed the capacity of the on-chip memory resources. In the simulation, data from off-chip memory resources can be accessed by compute engines such as data processing unit 210 and DSP 212 through data movement engine 216, with constraints on capacity and bandwidth. The simulation can log data is loaded into and out off-chip memory access 282 and how contention and arbitration by multiple processes accessing the off-chip memory resources can affect task scheduling and performance. Individual data movement or transfer tasks may have associated durations (e.g., durations calculated based on the constraints of off-chip memory access 282) to model the performance of data movement or transfer task being completed by off-chip memory access 282.

The SoC may have a SoC-side cache that serves an intermediate memory layer that sits between the DNN accelerator and off-chip memory. SoC cache access 266 model cache accesses (e.g., hits/misses, and time to access the data). The SoC-side cache is a shared resource with defined capacity, access latency, and bandwidth, allowing tasks from data movement engine 216 to temporarily store and retrieve data more quickly than from the off-chip memory. When a task requests data from the SoC-side cache, SoC cache access 266 can check if the data is present in the SoC-side cache. If it is, SoC cache access 266 can apply the cache's lower latency and higher bandwidth parameters when calculating the duration for completing the task. If the data is not present, SoC cache access 266 can model a cache miss, triggering a longer-latency data movement or transfer task to off-chip memory. SoC cache access 266 can model policies for eviction, replacement, and coherence, reflecting how real hardware manages shared cache resources. In some cases, SoC cache access 266 can model data transfer tasks to result in a hit a certain percentage of the time, and result in a miss otherwise. In some cases, SoC cache access 266 can model data transfer tasks to result in a hit at random, and result in a miss otherwise. The parameter for SoC cache access 266 hits or misses can be included as part of a configuration file. By simulating SoC cache access 266, the simulator can accurately capture the effects of cache hits and misses on overall system performance, analyze contention when multiple modules access the SoC-side cache simultaneously, and support optimization of data placement and scheduling strategies. SoC cache access 266 can help understand how memory hierarchy in a computing system impacts throughput, latency, and resource utilization in complex neural network workloads.

SoC interconnect 260 can include system-level communication pathways connecting DNN accelerator to other SoC components. SoC interconnect 260. SoC interconnect 260 models the pathways allowing data to move between the DNN accelerator and other SoC resources with defined bandwidth, latency, and arbitration policies. When a task requires data transfer outside the accelerator (for example, accessing off-chip memory or sharing data with another subsystem), Specifically, SoC interconnect 260 can have tasks that have associated costs or durations specified in configuration files or cost tables. The costs or durations can include one or more of transfer rates, arbitration policies, and pipeline depths. When a task requires data movement across interconnect 208, the simulator can check the availability of SoC interconnect 260 and apply modeled delays or bandwidth limits to record the time taken for data to traverse SoC interconnect 260 to reflect possible contention when multiple modules or tasks compete for access. In some embodiments, SoC interconnect 260 can also model priority schemes, multi-channel routing, and congestion effects, reflecting real-world hardware behavior. Ability to model SoC interconnect 260 can be particularly beneficial for simulating how system architecture and data movement affect throughput, latency, and resource utilization, supporting optimization of scheduling and data placement strategies for complex AI workloads.

Each component/block seen in FIG. 2 may have event data points logged and tracked to the specific component/block. Event data points can thus be tracked at the component/block level. The event data points can be aggregated to calculate the component/block's own set of statistics, such as the number of events, start/stop time stamps, and the amount of data computed or transferred associated with tasks/events. Upon completion of the simulation, all the performance statistics can be aggregated and combined into a large statistics report and compute a set of predefined performance metrics for the SoC.

### Power Modeling Through Power Nodes

Power analysis is preferably performed concurrently along with performance analysis and optimization, driven by real AI/ML model workload and use cases. Referring back to FIG. 1, power analysis operations 198 can be added to the performance analysis offered by event-based DNN execution simulator 194. As event-based DNN execution simulator 194 is run, activity sampling operation 120 and power calculation operation 122 can be performed to collect power consumption data points in accordance with SoC power model 160 and DNN accelerator power model 170.

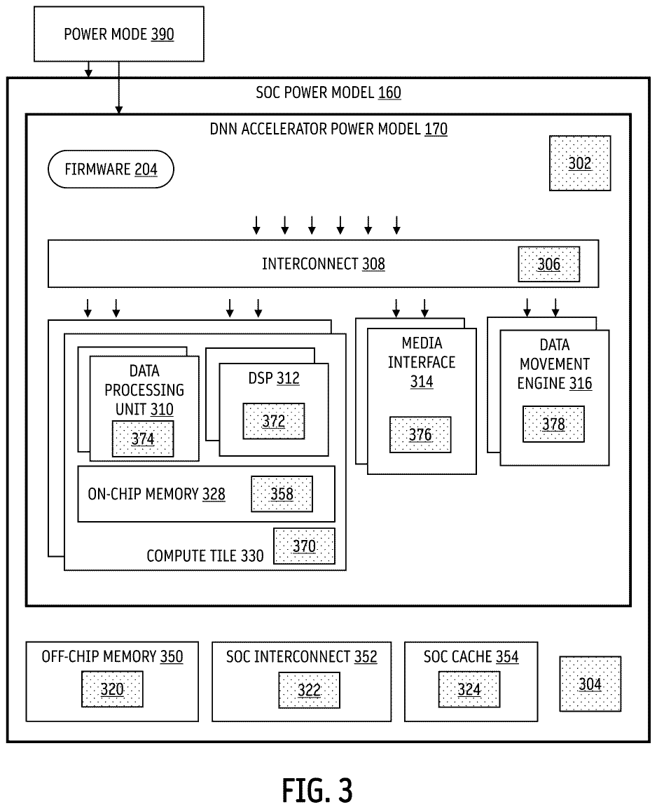

FIG. 3 illustrates modeling power consumption of a DNN accelerator using power nodes, according to some embodiments of the disclosure. SoC power model 160 and DNN accelerator power model 170 can include a hierarchically set of power nodes for the SoC and the DNN accelerator. Each power node may match or correspond to a physical partition according to the design hierarchy. Each design partition may be pre-characterized using RTL or gate level power simulation Electronic Design Automation (EDA) tools and a power virus vector to extract the maximum power consumption. A dynamic capacitance Cdyn value representing this maximum power consumption may be put into the power node data structure as a power cost for the power node.

Exemplary design partitions for the SoC can include one or more of: off-chip memory 350 of the SoC, SoC interconnect 352, SoC-side cache 354, SoC power model 160. Power node 320 may be designated for off-chip memory 350. Power node 322 may be designated for SoC interconnect 352. Power node 324 may be designated for SoC-side cache 354. Power node 304 may be designated for SoC power model 160 itself.

Exemplary design partitions for the DNN accelerator can include one or more of: interconnect 308, one or more instances of compute tile 330, one or more instances of media interface 314, and one or more instances of data movement engine 316. Power node 306 may be designated for interconnect 308. Power node 370 may be designated for each instance of compute tile 330. Power node 376 may be designated for each instance of media interface 314. Power node 378 may be designated for each instance of data movement engine 316. Power node 302 may be designated for DNN accelerator power model 170 itself.

Exemplary design partitions for a compute tile can include one or more of: on-chip memory 328, one or more instances of data processing unit 310, and one or more instances of DSP 312. Power node may be designated for on-chip memory 328. Power node 374 may be designated for each instance of data processing unit 310. Power node 372 may be designated for each instance of DSP 312. Power node 370 may be designated for each instance of compute tile 330 itself.

FIG. 3 illustrates that the hierarchy of power nodes is organized to mirror the physical and functional structure at different levels of the hierarchy: at the SoC level, at the DNN accelerator level, and at the compute tile level, etc. At the top level, a root power node represents the entire device or subsystem, and this node branches into child nodes that correspond to major hardware partitions at the level. Each child node can further subdivide into more granular nodes or partitions, reflecting, e.g., individual engines, parts, memory channels, and/or pipeline stages.

Every power node is characterized by parameters such as maximum dynamic power or dynamic capacitance (Cdyn), clock frequency, voltage, and activity factor, which are either measured from silicon or defined in configuration files. During simulation, each node dynamically calculates its power consumption based on real-time utilization and propagates this information up the hierarchy, allowing the system to aggregate power statistics at multiple levels, e.g., from fine-grained module traces to overall device power profiles. This hierarchical modeling illustrated in FIG. 3 enables detailed analysis of how different components contribute to total power usage, supports device power state management, and facilitates optimization of both performance and energy efficiency. The parameters corresponding to different power nodes can be stored in configuration files.

Using configuration files to store the parameters for different power nodes offers several key benefits for hardware simulation and modeling. The configuration files provide a structured, centralized way to define power and operational parameters for the partition for which the power node models, making it easy to adjust values such as dynamic and idle power coefficients, leakage characteristics, and mode-specific scaling factors without modifying source code. Configuration files support flexibility and scalability, allowing users to quickly adapt the simulation to different hardware versions, workloads, or optimization scenarios. Configuration files also improve reproducibility and transparency, as all modeling assumptions and parameters are documented and can be shared or version-controlled. Overall, configuration files streamline the process of calibrating, validating, and customizing simulations, enabling more accurate and efficient analysis of system behavior.

An exemplary configuration file for power node 374 designated for modeling power consumption of an instance of processing unit 310 can define the power modeling parameters for two hardware partitions of the instance of data processing unit 310, “top” and “scl”. For each partition, the configuration file specifies information such as the number of instances, the domain name, and key power metrics: dynamic power coefficients (cdyn_nf), idle power coefficients (cdyn_idle_nf), and leakage power characteristics (Ikg) with voltage and temperature dependencies. The configuration file also lists operational modes for integer and floating-point computation, providing scaling factors for each mode, and includes additional task-specific parameters such as feature map counts and pooling sizes. The structured data in the configuration file enables the simulator to accurately calculate power consumption for each instance of data processing unit 310 under different workloads and operating conditions.

An exemplary configuration file for power node 358 designated for modeling power consumption of on-chip memory 328 can define the power modeling setup for on-chip memory 328 partitioned into “logic” and “sram” partitions. For each partition, the configuration file specifies the instance count, domain name, dynamic power coefficients (cdyn_nf), idle power coefficients (cdyn_idle_nf), and leakage power parameters (Ikg), including voltage and temperature. The configuration file also defines operational modes for read and write operations, with scaling factors for each. By organizing these parameters in a configuration file, the simulator to model the energy and power usage of each instance of on-chip memory 328 during various data access patterns and system states, supporting detailed analysis of memory-related power consumption.

While each power node illustrated in FIG. 3 is defined with fine-grained parameters for each hardware partition, including details such as dynamic capacitance, voltage, clock frequency, and activity factor, organized hierarchically to reflect the physical structure of the hardware, the actual process of sampling power during simulation is straightforward. At each sampling interval, the simulator can collects the current activity factor for the power node, retrieves the relevant configuration values, and applies a formula to calculate instantaneous power consumption. Despite the detailed and hierarchical setup that enables highly accurate power modeling of different hardware blocks and their interactions, the runtime calculation during simulation to simulate power consumption involves just a direct multiplication of the sampled parameters, making power estimation both efficient and easy to implement.

Refer back to FIG. 1, SoC power model 160 and DNN accelerator power model 170 guides activity sampling operation 120 and/or power calculation operation 122. Performing activity sampling operation 120 and power calculation operation 122 can output power data points at the individual power node level and at different levels of the hardware hierarchy to collect data points operation 114 of statistics and metrics collection 196. During the simulation, each power node may be bound to a power modeling agent to perform activity sampling operation 120 (e.g., compute an activity factor) dynamically at a configurable interval based on events in the simulation (e.g., events simulated in event-based DNN execution simulator 194). The power modeling agent may also perform power calculation operation 122 to calculate the power consumption data point based on the parameters for the power node. Calculate metrics operation 116 can collect the power data to produce power consumption data in metrics 182.

In activity sampling operation 120, an activity factor at a power node associated with a circuit of the neural network accelerator is sampled during an interval. As discussed with FIG. 3, each power node represents a specific hardware partition or circuit within the neural network accelerator, such as a compute engine, memory block, or interconnect. During each simulation interval (for example, a power trace interval (PTI), the simulator calculates an activity factor for the power node. The simulation interval can be configurable. This activity factor quantifies how actively the circuit is being used, or simply the utilization of the hardware partition. The activity factor can be represented as a ratio of actual operations performed to the theoretical maximum. The activity factor can be dynamically extracted from tasks, events, and/or states of the simulation collected during simulation, reflecting real-time utilization based on the current workload and scheduling

Different power nodes may use different schemes to derive the activity factor, depending on the nature of the corresponding hardware partition. For example, the power node of the compute-type hardware partitions such as data processing unit 310 and DSP 312 may determine the activity factor based on utilization of the compute resource using the formula:

$$Activity\_factor = utilization = \frac{actual\_computed \_ops}{ideal\_computed \_ops}$$

The activity factor may be calculated based on actual computed operations divided by ideal computed operations for a compute engine. In some embodiments, activity sampling operation 120 can include calculating a ratio of a number of completed tasks within an interval and a number of tasks that the circuit of the neural network accelerator is able to complete.

For example, the power node of memory-type hardware partitions such as on-chip memory 328, off-chip memory 350 and SoC-side cache 354, may determine the activity factor based on bandwidth (BW) utilization using the formula:

$$utilization = \frac{effective\_BW}{maximum\_BW}$$

The activity factor may be calculated based on effective bandwidth divided by maximum bandwidth for a memory block. In some embodiments, activity sampling operation 120 can include calculating a ratio of effective bandwidth and a maximum bandwidth of the circuit of the neural network accelerator.

In power calculation operation 122, a power consumption data point at the power node for the interval is calculated based on one or more of: the activity factor, a clock frequency, a voltage, and a dynamic capacitance of the circuit. These parameters are either measured from silicon or specified in configuration files and may vary for different operating modes or hardware partitions. Using the pre-configured Cdyn, clock frequency and voltage as well as the activity factor, the power node can compute its effective power consumption for the corresponding interval. The formula to compute effective power consumption is:

$${P}_{eff} = Freq \times {Volt}^{2} \times Cdyn \times Activity\_factor$$

By combining these factors, the simulator produces a realistic estimate of power usage for each hardware block during the interval, enabling detailed analysis of energy efficiency, peak power events, and the impact of workload scheduling on overall system power consumption.

Referring back to FIG. 3, SoC power model 160 and/or DNN accelerator power model 170 may take into account power mode 390 when calculating power consumption data points. The power node can calculate the power consumption data point further based on power mode 390 of neural network accelerator during the interval. The power node can adjust its calculations (e.g., the parameters being used for calculating the power consumption data points) based on different operating conditions, such as changes in frequency and voltage (using a preset curve), and changes in leakage power depending on voltage and temperature. By adjusting the parameters based on specific power states, such as active, idle, or standby/ready, the simulator can simulate power consumption under different power modes to build a detailed power profile and key power statistics for each use case, reflecting how the hardware's energy use shifts as it runs different tasks and moves between power states.

The final power consumption profile can be rolled up by collecting the power statistics of all power nodes.

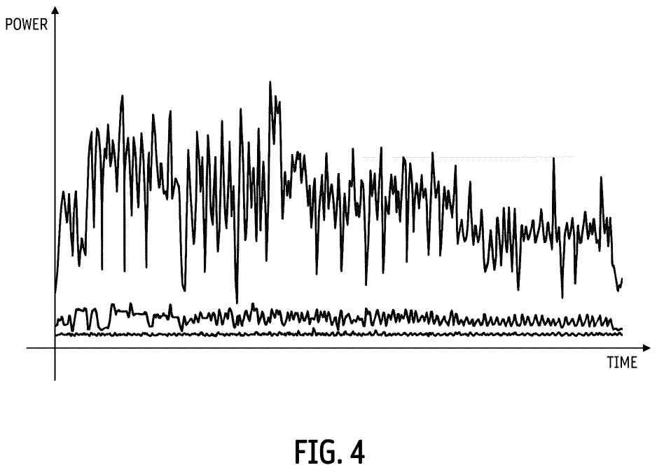

FIG. 4 illustrates a power trace, according to some embodiments of the disclosure. Specifically, FIG. 4 illustrates a power trace having several plots to capture peak power characteristics for different power nodes under a specific AI/ML workload. Power consumption profile can be presented as a power trace over the duration of the model inference.

### Hierarchical Nature in Performance and Power Modeling

The models illustrated in FIGS. 2-3 illustrate the strategic approach to model the operational behavior and power consumption of the DNN accelerator in a hierarchical manner.

In some embodiments, the operational behavior of DNN accelerator hardware is modeled as a hierarchy of blocks as seen in FIG. 2. Specifically, the operational behavior of DNN accelerator is modeled using a hierarchical structure of global and local task queues, mirroring the hierarchy of blocks as seen in FIG. 2. At the top level, a global scheduler in firmware (emulated in the simulation) manages the distribution of tasks across hardware components, while each component/block as seen in FIG. 2 maintains one or more local task queues to process tasks independently. A component/block as seen in FIG. 2 can have multiple local task queues to model parallel and/or pipelining behavior within the component/block. This architecture enables fine-grained modeling of concurrent operations, synchronization, and resource contention, accurately reflecting real-world system dynamics. The hierarchical queue system is significant because it allows the event-based DNN execution simulator to simulate complex interactions between firmware and hardware effectively and efficiently without having to perform cycle-based simulations. The hierarchical approach is also modular and flexible, making it possible to implement the event-based DNN execution simulator on complex hardware and adapt the simulator to newer hardware architectures easily and transparently

In some embodiments, the power consumption of DNN accelerator hardware is modeled as a hierarchy of blocks as seen in FIG. 3. Specifically, the operational behavior of DNN accelerator is modeled using a hierarchical structure of power nodes, mirroring the hierarchy of blocks as seen in FIG. 3. Notably, the operational behavior/activity is captured in the event-based DNN execution simulator in parallel for the hierarchy of blocks as seen in FIG. 2, which can be used to calculate activity factors for the various power nodes. A component/block may be partitioned further to include a plurality of power nodes to model sub-component/block level power consumption more accurately. The hierarchical structure of power nodes, created according to the hardware partitioning of the DNN accelerator enables precise aggregation of power metrics from individual components up to the full system, while supporting dynamic power state management simulation and dynamic voltage/frequency scaling. The hierarchical structure of power nodes can provide accurate, component-level power profiling and optimization, facilitating joint performance-power analysis and power mode simulation. Moreover, the hierarchical approach is also modular and flexible, making it possible to model power consumption on complex hardware and adapt the modeling to newer hardware architectures easily and transparently.

Closing the Loop: Utilizing Simulation Data to Feedback into Analysis and Design

Event-based DNN execution simulator 194 can produce simulation data, having one or more of: one or more event data points and statistics and/or metrics 182. The simulation data can be sent to tools such as VPUNN, MoviSim ISS, and SIMICS ISS. The tools can consume the simulator's data and produce calibrated performance that feed back into analysis and design. For example, the data, e.g., timestamps (dispatch/start/finish), processing queue states, utilization, bandwidth, stall counts, and power consumption data points, can serve as the normalized feature set that VPUNN uses to predict task latency/throughput under specific tiling, stencil, and DSP data width choices. The data can be used by Movisim ISS to generate instruction-accurate kernel timings and per-stage counters for validating or refining cost tables. The data can be used by SIMICS ISS uses to profile firmware/driver interactions, barrier overheads, and system-level contention across SoC interconnect paths. Together, these tools and other tools can operate on simulator data to correlate predicted and measured costs, update JSON/YAML cost tables, and surface bottlenecks via metrics like p95 latency, deadline-miss rate, bytes-per-cycle, and eTOPS/W-closing the loop between event data points, cost modeling, and optimization.

### Full-Stack End-to-End Modeling

In various embodiments, joint performance-power optimization framework 100 can be extended to model any latency/key performance indicators (KPI) outside of the SoC or DNN accelerator. Joint performance-power optimization framework 100 can be extended to include DNN accelerator firmware control components (job scheduling manager, inference manager, inference runtime) and host stack layers ((OpenVINO plugin, compiler, User Mode Driver (UMD), Operating System (OS), KMD (Kernel Mode Driver)). By modeling those software (SW) stack components, the simulation can provide not only hardware (HW) frames per second (FPS), but also throughput FPS and E2E FPS which can be much closer to the silicon results measurement at E2E application level.

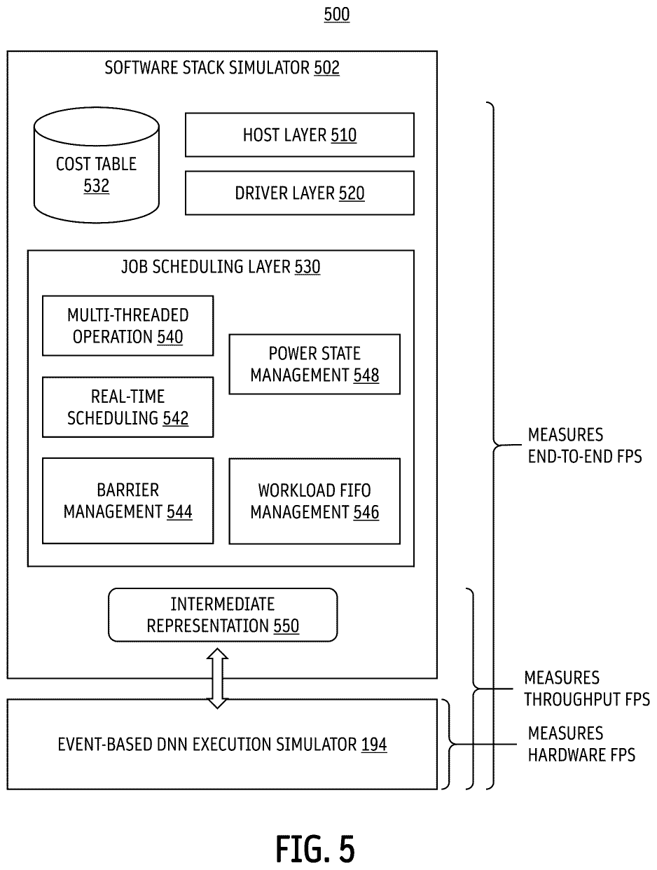

FIG. 5 illustrates end-to-end modeling framework 500 of a computing system having a host processor and a DNN accelerator, according to some embodiments of the disclosure. End-to-end modeling framework 500 includes software stack simulator 502, which can emit tasks and interact with event-based DNN execution simulator 194. End-to-end modeling framework 500 can be referred to as an end-to-end simulator. Software stack simulator 502 can include host layer 510, driver layer 520, job scheduling layer 530, and intermediate representation 550. Software stack simulator 502 is a model that represents the different layers of software involved in running neural network workloads on a DNN accelerator. Host layer 510 includes the application and user-level software that interacts with the accelerator, such as AI frameworks or plugins. Driver layer 520 includes the software drivers that manage communication between the host and the hardware, including user mode and kernel mode drivers. Job scheduling layer 530 is responsible for managing the submission, queuing, and dispatch of inference jobs to the DNN accelerator, often implemented as firmware or middleware. Intermediate representation 550 refers to the format in which neural network models are converted for efficient execution, such as compiled graphs or optimized kernels. Each layer of software stack simulator 502 represents a part in the end-to-end execution pipeline. Modeling them in simulation helps capture software-induced delays and interactions, leading to more realistic performance predictions in an end-to-end manner.

In addition, software stack simulator 502 can simulate multi-threaded operation to emulate barrier synchronization, contention for resources, and preemption by different threads having higher QoS level. Simulating multi-threaded operation with preemption in software stack simulator 502 enables end-to-end modeling framework 500 to realistically capture how modern neural network accelerators and their supporting software handle multiple tasks and workloads in parallel. Multi-threaded operation allows computing systems to process several jobs at once, increasing overall throughput and efficiency. Moreover, these computing systems can support preemption, which supports interrupting or temporarily pausing lower-priority tasks when higher-priority or time-sensitive tasks arrive, ensuring that critical workloads meet their deadlines and quality-of-service demands. By including these features in software stack simulator 502, architects and developers can analyze the impact of concurrency, resource contention, and scheduling policies on end-to-end performance, identify bottlenecks, and optimize both hardware and software for real-world, multi-user scenarios. This leads to more accurate predictions of system behavior and better design decisions for complex AI deployments.

Several parts are modeled in job scheduling layer 530. Job scheduling layer 530 can include one or more of multi-threaded operation 540, real-time scheduling 542, barrier management 544, and workload FIFO management 546. Job scheduling layer 530 can model how inference jobs are organized and dispatched to the DNN accelerator. Multi-threaded operation 540 allows the system to simulate job scheduling behavior by generating several inference threads to maximize the parallelism between memory copy and inference and simulating handling multiple jobs or tasks in parallel. Real-time scheduling 542 implements scheduling strategies that prioritize tasks based on timing requirements, ensuring that critical jobs meet their deadlines. For example, real-time scheduling 542 can mimic different operating system scheduling strategies like round-robin, first-come-first-served, etc. Barrier management 544 models costs associated with performing tasks associated with synchronization points or barriers, which ensures that tasks only proceed when dependencies are resolved and resources are available. Workload FIFO management 546 models costs associated with performing tasks associated with enqueuing and dequeuing tasks in first-in, first-out processing queues, which are used to control the order in which jobs are processed and dispatched. Each of these components helps job scheduling layer 530 accurately simulate how real firmware and the software stack manages concurrency, timing, synchronization, and task flow in a computing system having a neural network accelerator.

Barrier management 544 and workload FIFO management 546 have been identified as major performance cost contributors during runtime besides the DNN accelerator itself. Although firmware has many variants of barrier and workload management schemes and costs associated with barrier and workload management can be differ with different compiler strategies, the variations can be abstracted by organizing cost entries in cost table 532 to suit, e.g., a given kind of barrier and workload management scheme, and a particular kind of compiler strategies. Cost table 532, e.g., stored as one or more configuration files, can be injected into modeling/simulation statically or dynamically during simulation. Costs in cost table 532 can be pre-measured from silicon with different configured firmware.

In some embodiments, barrier management 544 can model costs, such as latency, associated with tasks for barrier management. A configuration file for barrier management 544 can define the timing parameters for different stages of a barrier operation in a simulation. The time unit is specified as “cycle,” meaning the latency values are measured in clock cycles. Under the “stage” list, two stages are described: “BarrierConfig” with a latency of 270 cycles, and “BarrierISR” with a latency of 20 cycles. This means that configuring the barrier takes 270 cycles, while the interrupt service routine (ISR) for the barrier takes 20 cycles. By specifying these values, the configuration file enables the simulator or model to account for the time spent in each barrier-related operation, supporting accurate modeling of synchronization overhead in the system.

In some embodiments, workload FIFO management 546 can model costs, such as latency, associated with tasks for managing workloads in processing queues associated with threads. A configuration file for workload FIFO management 546 can specify the timing parameters for different stages of a workload operation in a simulation, with latency values measured in clock cycles. The configuration file can define one or more stages: “WLPageLoad,” which loads a page of size 64 and takes 4800 cycles; “WLEnqueue,” which enqueues a workload and takes 140 cycles; and “DMAEnqueue,” which enqueues a DMA operation and takes 700 cycles. By listing these stages and their associated latencies, the configuration file enables the simulator to account for the time spent in each part of the workload FIFO management process, supporting accurate modeling of task scheduling and resource management in the system.

Extending event-based DNN execution simulator 194 (or incorporating SoC task model 140, DNN accelerator task model 150, SoC power model 160, and DNN accelerator power model 170) into software stack simulator 502 turns a fast, hardware-centric performance model into a full-system simulator that captures the real end-to-end behavior of an AI workload in a multi-pipelined context. Using event-based DNN execution simulator 194, it is possible to measure hardware FPS and throughput FPS by modeling compute, memory, interconnect, and firmware events. Adding software stack simulator 502 means that software-induced latencies (queuing, synchronization, driver and OS overhead) are exposed, enabling the simulator to report end-to-end FPS (or application-level FPS) that closely matches silicon measurements at application level. Practically, software stack simulator 502 facilitates (1) analyzing QoS and preemption across pipelines, (2) attributing time and power to both HW and SW components, (3) tuning schedules and power states to meet deadlines and battery targets, and (4) iterating quickly by editing declarative configuration files (e.g., cost table 532) to compare parameters. Software stack simulator 502 also exposes intermediate representation 550, which can allow throughput FPS to be measured. Throughput FPS refers to the rate at which the hardware and software layers can process and complete inference tasks or frames in a neural network workload, e.g., at the task-level of a neural network model. Unlike hardware FPS, which measures only the raw performance of the accelerator hardware, throughput FPS accounts for additional delays and overheads introduced by software stack components such as job scheduling, driver interactions, processing queue management, and synchronization. This metric provides a more realistic measure of how quickly the system can deliver results to the end user, reflecting the combined efficiency of hardware execution and software orchestration. Throughput FPS can measure the true performance bottlenecks in complex, real-world AI deployments and enable optimization of the performance bottlenecks. End-to-end modeling framework 500 is decision tool for system-level co-optimization that can align compiler, firmware, drivers, and hardware so that the product meets performance, efficiency, and user-experience goals under realistic, multi-pipeline workloads.

Besides supporting end-to-end use case level simulation and pipelining, software stack simulator 502 and event-based DNN execution simulator 194 can simulate scenarios where multi-context, multi-tile concurrency for each pipeline is implemented to maximize the performance and DNN accelerator utilization. This means that software stack simulator 502 and event-based DNN execution simulator 194 can simulate running multiple applications like a Teams meeting and a generative AI/ML application running on different compute tiles to minimize resource contention and preemption. Allowing for multi-context, and multi-tile utilization for different pipelines can be user-configurable in the input configuration file to the end-to-end simulation framework.

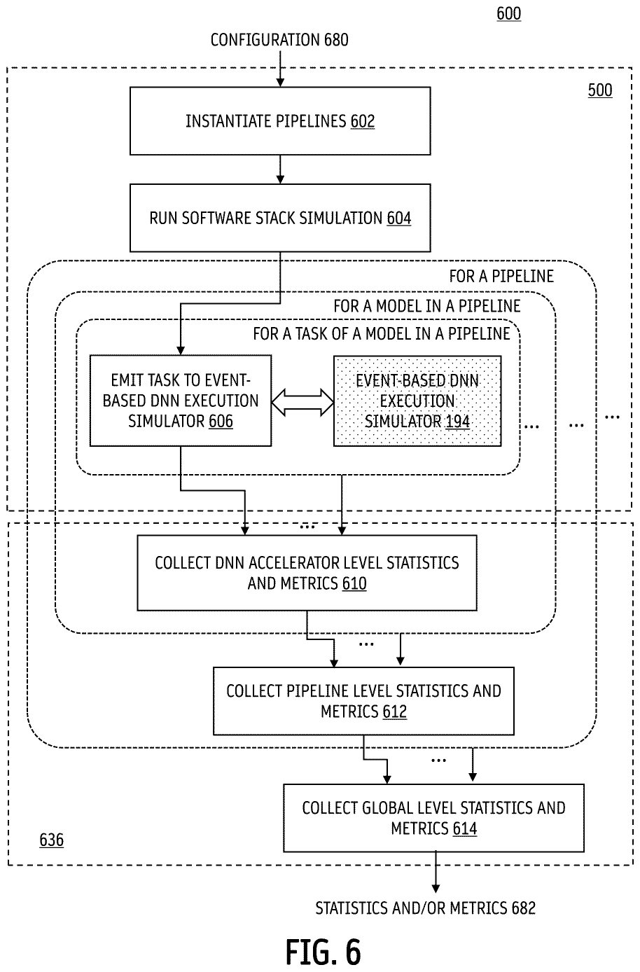

FIG. 6 illustrates process 600 for joint performance-power end-to-end modeling of execution of one or more pipelines on a computing system, according to some embodiments of the disclosure. Process 600 can be carried out by end-to-end modeling framework 500 and statistics and metrics collection 636.

End-to-end modeling framework 500 may receive configuration 680. Configuration 680 can include or specify one or more pipelines. A pipeline can include one or more neural network model executions and one or more scheduling policies. In some embodiments, configuration 680 defines the scheduling and resource allocation policies for multiple pipelines in end-to-end modeling framework 500. Each pipeline entry can include a “policy” section and a “models” section. The “policy” section specifies one or more of: whether the pipeline is sequential or not, the starting offset (when the pipeline begins relative to the start of simulation time), the interval between runs, and the total count of runs. These fields can control the timing and repetition of pipeline execution simulation. The “models” section lists one or more neural network models assigned to the pipeline, with each model entry specifying one or more of the model name, QoS priority, a list of compute tiles to use (identified by compute tile identifiers), and a list of memory contexts (identified by context IDs) for data movement. These fields determine which resources are allocated to each model and how tasks are distributed across compute engines to allow for multi-context, multi-tile concurrency execution simulation. These fields enable precise control over scheduling, concurrency, resource partitioning, and priority management for complex multi-model, multi-pipeline workloads, supporting efficient and flexible simulation or deployment on neural network accelerators.

Using configuration 680, a user can specify scheduling information for each pipeline including one or more of: interval period, starting offset, count of run times. Each pipeline may include a list of models belonging to the pipeline. Optionally, the user can specify hardware/firmware configurations for each model to simulate, including one or more of: compute tiles, data movement engine channels, QoS level, count of repeat times, etc. With preemption supported in the end-to-end modeling framework 500, different pipelines and/or different models in the various pipelines can be assigned different priority level based on importance.

In some embodiments, a model execution specified in in configuration 680 include one or more of: one or more context identifiers and one or more compute tile identifiers. In some embodiments, the one or more neural network model executions in configuration 680 include an identifier of the neural network model executions and a quality-of-service value. In some embodiments, the one or more scheduling policies in configuration 680 comprise one or more of: an indicator that indicates whether the one or more models are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.

In instantiate pipelines operation 602, end-to-end modeling framework 500 can instantiate one or more threads corresponding to the one or more pipelines. A thread of the one or more threads can correspond to a pipeline of the one or more pipelines. One or more thread can be instantiated per pipeline defined in configuration 680. Furthermore, end-to-end modeling framework 500 can decompose a neural network model execution of the one or more neural network model executions specified for the pipeline in configuration 680 into one or more tasks according to one or more parameters of the neural network accelerator. Task generation and decomposition can be similar to performing one or more of: ingest and parse operation 102, task generation operation 104, and task decomposition operation 106 of FIG. 1. End-to-end modeling framework 500 can enqueue the one or more tasks of the neural network model execution to the thread (e.g., to a processing queue of the thread) corresponding to the pipeline. Once the tasks are generated, end-to-end modeling framework 500 can assign them to the appropriate thread's processing queue. Each thread may represent a pipeline, or a specific hardware or software execution context, such as a memory context, a compute engine, or a firmware thread for the pipeline. The tasks are placed in the processing queue in an order that respects dependencies and scheduling policies, allowing the thread to process them sequentially or in parallel as resources become available. Task queuing enables efficient scheduling, synchronization, and resource management, ensuring that all parts of the accelerator are utilized effectively during model execution.

In run software stack simulation operation 604, end-to-end modeling framework 500 can run a simulator (e.g., an event-based simulator) that simulates multi-thread scheduling of the one or more threads according to the one or more scheduling policies and resource availability. The software stack simulator advances a simulation time according to one or more durations corresponding to the one or more tasks and updates one or more states of the one or more threads according to the multi-thread scheduling.

In some embodiments, the software stack simulator simulates multi-thread scheduling of the one or more threads by scheduling the one or more threads based on one or more of: a round-robin schedule, and a first-come-first-served schedule.

In some embodiments, the software stack simulator simulates preemption, where the software stack simulator simulates multi-thread scheduling of the one or more threads further according to the quality-of-service value specified for a model execution or a pipeline.

In some embodiments, end-to-end modeling framework 500 may decompose the neural network model execution further into one or more task dependencies and ensure that the task dependencies are handled when enqueuing the tasks to the threads. The software stack simulator in end-to-end modeling framework 500 can advance the simulation time further based on one or more of: a task dependency of the one or more task dependencies being configured, and the task dependency of the one or more task dependencies being triggered. Referring briefly back to FIG. 5, barrier management 544 and cost table 532 can be used to model how to advance the simulation time when a barrier synchronization or task dependency event occurs.

In some embodiments, the software stack simulator in end-to-end modeling framework 500 may advance the simulation time further based on one or more of: a cost of loading data onto a processing queue of a thread, a cost of adding a task to a processing queue of a thread, and a cost of adding a data movement task to a processing queue of a thread, to account for workload FIFO management. Referring back to FIG. 5, workload FIFO management 546 and cost table 532 can be used to model how to advance the simulation time to account for managing the task queues of various threads.

In some embodiments, the software stack simulator for end-to-end modeling framework 500 can perform emit task to event-based DNN execution simulator operation 606 for each task of each neural network model execution in a pipeline. In emit task to event-based DNN execution simulator operation 606, the software stack simulator can simulate a task from a thread being processed by a DNN accelerator by running an event-based DNN execution simulator, e.g., event-based DNN execution simulator 194 as described herein. The event-based DNN execution simulator runs inside the software stack simulator for end-to-end modeling framework 500 to advance the same simulation time. Moreover, the event-based DNN execution simulator performs the operations as described in FIGS. 1-3, e.g., to model the performance of the DNN accelerator hardware through global/environment task queues and component/block task queues. The tasks emitted in emit task to event-based DNN execution simulator operation 606 can enqueue the tasks onto one or more global/environment task queues being modeled in the event-based DNN execution simulator. The event-based DNN execution simulator can then dispatch and complete tasks in the one or more global/environment task queues to one or more local task queues for processing and event logging.

For every pipeline or specific context of a pipeline defined configuration 680, the simulation iterates through each model execution assigned to that pipeline. For each model execution, the simulation decomposes the model execution into smaller tasks according to the hardware configuration. Each of these tasks is then “emitted”, e.g., sent or submitted, to the event-based DNN execution simulator (e.g., event-based DNN execution simulator 194). In some embodiments, the event-based DNN execution simulator can add the task to an appropriate queue of the event-based DNN execution simulator for processing by the event-based DNN execution simulator. The event-based DNN execution simulator can model how tasks are processed, scheduled, and completed by the hardware, taking into account dependencies, resource availability, and timing in the hardware. By emitting tasks in this structured way for every model in every pipeline, the simulation can accurately represent the end-to-end interactions from the software-level (e.g., the threads) down to the hardware-level (e.g., the event-based DNN execution simulator). The end-to-end interactions can include parallelism, task flow, and system-level interactions in the entire workflow from the initial scheduling of neural network model executions (including software stack layers, job scheduling, and resource allocation) all the way through to the actual execution of tasks on the DNN accelerator. Understanding the interactions can enable detailed analysis of performance, bottlenecks, and throughput across complex multi-model, multi-pipeline workloads.

As discussed previously with FIGS. 1 and 3, power consumption data points can be obtained from event-based DNN execution simulator through activity sampling and power consumption calculation. The event-based DNN execution simulator can support sampling an activity factor at a power node associated with a circuit of the neural network accelerator during an interval, and calculating a power consumption data point at the power node for the interval based on one or more of: the activity factor, a clock frequency, a voltage, a dynamic capacitance of the circuit, and a power mode of the neural network accelerator during the interval.

In practice, the use case at the application level can influence the power mode of the DNN accelerator. Since use case usually lasts long durations to cover different periods of pipelines, at some point, the DNN accelerator may fall into low power state during the gap between two active neural network model execution. Referring briefly back to FIG. 5, software stack simulator 502 includes power state management 548 to accurately model the power consumption for entire use case simulation. Power state management 548 can run power state management model in the background, based on the states of the threads in the simulation to track current power state. Power state management 548 can have an associated configuration file that specifies how power state is managed based on periods of inactivity or one or more other heuristics. A user can specify different behaviors for power state management 548 to evaluate power consumption.

In some embodiments, the software stack simulator of end-to-end modeling framework 500 can advance the simulation time further based on one or more of: a latency to transition from an active state of the neural network accelerator to an idle state of the neural network accelerator, and a further latency to transition from the idle state to an active state of the neural network accelerator. The latencies can be defined in a cost table (e.g., cost table 532 of FIG. 3), such as in a configuration file. Each power state transition time and cost may be configurable through power cost table.

Statistics and metrics collection 636 can included one or more of: collect DNN accelerator level statistics and metrics operation 610, collect pipeline-level statistics and metrics operation 612, and collect pipeline-level statistics and metrics operation 614.

In some embodiments, collecting DNN accelerator level statistics and metrics operation 610 involves gathering detailed performance and/or power data from the event-based DNN execution simulator, such as performance and/or power of compute engines, memory blocks, and interconnects. The data can include recording task latencies, resource utilization, bandwidth usage, and queue wait times for each block during simulation.

In some embodiments, collecting pipeline-level statistics and metrics operation 612 shifts the focus from individual hardware components to the entire sequence of models and tasks that make up a processing pipeline. This operation combines hardware statistics with software-induced delays, such as scheduling overhead, synchronization barriers, and queue management. The pipeline-level data can tracks end-to-end latency, throughput, deadline-miss rates, and the impact of preemption or resource contention across all models in the pipeline. By analyzing these metrics, developers can optimize scheduling policies, resource allocation, and concurrency strategies to improve overall pipeline performance and responsiveness.

Collecting global-level statistics and metrics operation 614 aggregates data across all active pipelines and contexts in the system, providing a comprehensive view of system-wide behavior. This includes measuring total throughput, cross-pipeline interference, resource occupancy, and overall power consumption under realistic multi-pipeline workloads. Global metrics help architects and decision-makers compare different scheduling configurations, assess system scalability, and ensure that performance and efficiency targets are met for complex, real-world AI deployments. This holistic analysis is useful for guiding and iterating through design choices and validating that the system can handle diverse and demanding use cases.

In some embodiments, statistics and metrics collection 636 can collect one or more event data points for the one or more tasks and the one or more pipelines based on the simulation time of end-to-end modeling framework 500 and one or more states of the one or more threads. The one or more event data points include one or more of: one or more task start times and one or more task completion times associated with the one or more tasks. Statistics and metrics collection 636 can output statistics and/or metrics 682.

In some embodiments, statistics and metrics collection 636 can calculate one or more performance metrics based on the one or more event data points. The one or more performance metrics comprises one or more of: a processing queue wait time, a task queue wait time, deadline-miss indicator, per-pipeline latency, a frames per second measurement, an average latency, a deadline-miss rate, and a per-block utilization.

In some embodiments, statistics and metrics collection 636 can include statistics of each pipeline performance including FPS, average latency, and deadline-miss rate (associated with models/pipelines having QoS levels), etc. In some embodiments, statistics and metrics collection 636 can include each power state active percentage.

### Replay Mode

Event-based DNN execution simulator 194 and the software stack simulator of end-to-end modeling framework 500 of the various figures replay mode which allows user to pass a list of pre-simulated results to accelerate future use case simulation. In replay mode, a visualization of task execution over simulation time can be generated based on the one or more event data points collected during simulation, e.g., from past simulation runs. Since use case level simulation requires a lot of models to simulate including large language models (LLMs) and Gen-AI/ML models, the simulation time could be several days and even weeks. Replay mode can solve this problem by asking a user to generate all single-model execution results (e.g., sometimes in parallel) beforehand and then passing these existing results to the tool for future use case level simulation. Replay mode can enable rapid, scalable simulation of complex DNN accelerator-based AI inference use cases by allowing users to pre-simulate individual model executions and store their results as reusable traces. During full use case simulations, these pre-simulated results are replayed according to user-defined pipeline configurations, eliminating the need to re-run detailed model simulations and dramatically reducing overall simulation time. The simulation time can be hence shortened at least 50× and results comparing to non-replay mode is within 1% tolerance.

### Data Visualizations

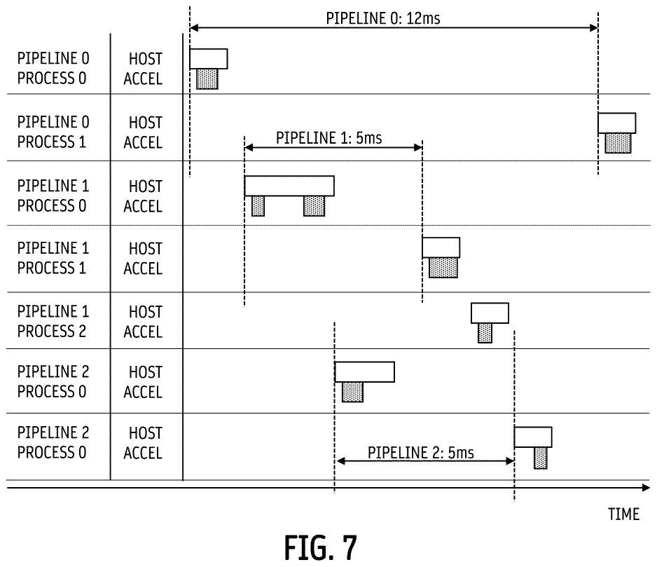

FIG. 7 illustrates a visualization of task execution over simulation time for a plurality of pipelines and processes, according to some embodiments of the disclosure. The visualization allows a user to understand a use case pipeline scheduling and execution within a computing system having a DNN accelerator.

The visualization includes three pipelines (PIPELINE 0, PIPELINE 1, and PIPELINE 2). Each pipeline can include processes/threads that are executed over time. For each process, the diagram shows the processing activity and time for host processing (labeled “HOST”) and accelerator execution (labeled “ACCEL”). Processing activity is represented by blocks along the time axis. Within each pipeline, individual processes are scheduled such that host and accelerator tasks may overlap or execute in sequence, reflecting concurrent and pipelined operation across multiple hardware resources. Visualization demonstrates how multi-threaded operation of the software stack and models parallelism, resource contention, and scheduling dependencies between host and accelerator components for each process.

The wait time metric for PIPELINE 0 can be 12 milliseconds. The wait time metric for PIPELINE 1 can be 5 milliseconds. The wait time metric for PIPELINE 2 can be 5 milliseconds.

The visualization showcases behavior of multi-pipeline, multi-process scheduling, including the timing relationships and resource allocation between host and accelerator tasks. The visualization can enable analysis of system-level performance metrics such as latency, throughput, and deadline adherence, supporting comprehensive optimization of AI inference workloads running on DNN accelerators.

### Exemplary Methods for Simulating Execution of One or More Neural Network Models

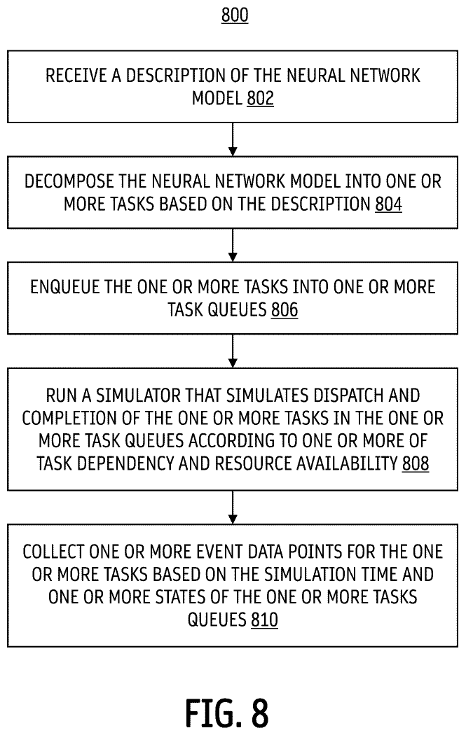

FIG. 8 is a flow diagram illustrating method 800 for simulating an execution of a neural network model, according to some embodiments of the disclosure.

In 802, a description of the neural network model is received. The description includes one or more of: a model definition, an intermediate representation, and a compiled binary representation.

In 804, the neural network model is decomposed into one or more tasks based on the description. In 806, the one or more tasks are enqueued into one or more task queues.

In 808, a simulator is run or executed. The simulator simulates dispatch and completion of the one or more tasks in the one or more task queues according to one or more of task dependency and resource availability. The simulator advances a simulation time according to one or more durations corresponding to the one or more tasks and updates one or more states of the one or more task queues according to the dispatch and the completion of the one or more tasks.

In 810, one or more event data points for the one or more tasks are collected based on the simulation time and one or more states of the one or more task queues. The one or more event data points include one or more of: one or more task start times and one or more task completion times associated with the one or more tasks.

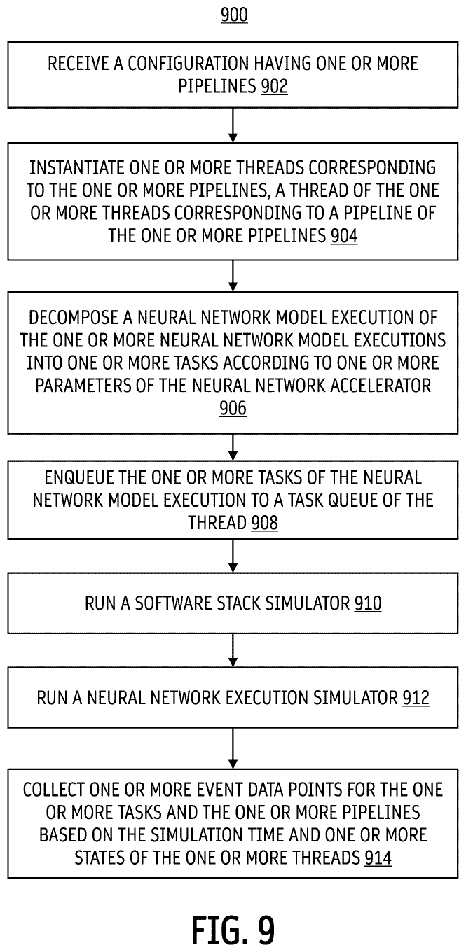

FIG. 9 is a flow diagram illustrating method 900 for simulating an execution of a neural network model, according to some embodiments of the disclosure.

In 902, a configuration having one or more pipelines is received. A pipeline of the one or more pipelines includes one or more neural network model executions and one or more scheduling policies.

In 904, one or more threads corresponding to the one or more pipelines can be instantiated. A thread of the one or more threads can correspond to a pipeline of the one or more pipelines.

In 906, a neural network model execution of the one or more neural network model executions is decomposed into one or more tasks according to one or more parameters of the neural network accelerator.

In 908, the one or more tasks of the neural network model execution are enqueued to the thread.

In 910, a software stack simulator is run or executed. The software stack simulator multi-thread scheduling of the one or more threads according to the one or more scheduling policies and resource availability. The software stack simulator advances a simulation time according to one or more durations corresponding to the one or more tasks and updates one or more states of the one or more threads according to the multi-thread scheduling.

In 912, a neural network execution simulator is run or executed. The neural network execution simulator simulates dispatch and completion of the one or more tasks in one or more task queues according to one or more of task dependency and further resource availability. The neural network execution simulator advances the simulation time according to one or more durations corresponding to the one or more tasks and updates one or more states of the one or more task queues according to the dispatch and the completion of the one or more tasks. The task queues can be set up hierarchically as described in FIGS. 1-2.

In 914, one or more event data points for the one or more tasks and the one or more pipelines are collected based on the simulation time. The one or more event data points include one or more of: one or more task start times and one or more task completion times associated with the one or more tasks.

### Exemplary Computing Device

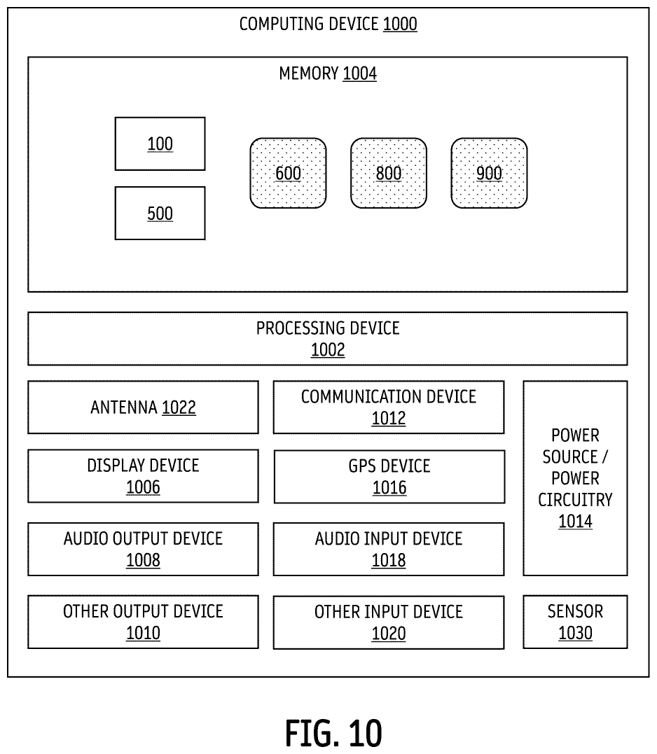

FIG. 10 is a block diagram of an apparatus or a system, e.g., an exemplary computing device 1000, according to some embodiments of the disclosure. One or more computing devices 1000 may be used to implement the functionalities described with the FIGS. and herein. A number of components illustrated in FIG. 10 can be included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single SoC die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

Computing device 1000 may include a processing device 1002 (e.g., one or more processing devices, one or more of the same types of processing device, one or more of different types of processing device). The processing device 1002 may include electronic circuitry that processes electronic data from data storage elements (e.g., registers, memory, resistors, capacitors, quantum bit cells) to transform that electronic data into other electronic data that may be stored in registers and/or memory. Examples of processing device 1002 may include a CPU, a GPU, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a field programmable gate array (FPGA), a tensor processing unit (TPU), a neural network hardware accelerator, a DNN hardware accelerator, etc.

Computing device 1000 may include a memory 1004, which may itself include one or more memory devices such as volatile memory (e.g., DRAM), non-volatile memory (e.g., read-only memory (ROM)), high-bandwidth memory (HBM), flash memory, solid state memory, and/or a hard drive. Memory 1004 includes one or more non-transitory computer-readable storage media. In some embodiments, memory 1004 may include memory that shares a die with the processing device 1002.

In some embodiments, memory 1004 includes one or more non-transitory computer-readable media storing instructions executable to perform operations described with the FIGS. and herein. Memory 1004 may include one or more non-transitory computer-readable media storing instructions executable to perform one or more operations described with process 600 of FIG. 6. Memory 1004 may include one or more non-transitory computer-readable media storing instructions executable to perform one or more operations described with method 800 of FIG. 8. Memory 1004 may include one or more non-transitory computer-readable media storing instructions executable to perform one or more operations described with method 900 of FIG. 9. One or more parts, e.g., one or more components in joint performance-power optimization framework 100 and one or more components in end-to-end modeling framework 500, may be encoded as instructions and stored in memory 1004. The instructions stored in the one or more non-transitory computer-readable media may be executed by processing device 1002.

In some embodiments, memory 1004 may store data, e.g., data structures, binary data, bits, metadata, files, blobs, etc., as described with the FIGS. and herein. Memory 1004 may store inputs, intermediate inputs, intermediate outputs, and outputs the process illustrated in FIGS. 1, 5, process 600, method 800 of FIG. 8, and method 900 of FIG. 9. Memory 1004 may store one or more of: model description 180 of FIG. 1, metrics 182 of FIG. 1, cost tables and/or configuration files for SoC task model 140, cost tables and/or configuration files for task model 150, configuration files for SoC power model 160, configuration files for power model 170, cost table 532, intermediate representation 550, configuration 680, and metrics 682.

In some embodiments, memory 1004 may store one or more DNNs (and or parts thereof). Memory 1004 may store training data for training (trained) a DNN. Memory 1004 may store instructions that perform operations associated with training a DNN. Memory 1004 may store input data, output data, intermediate outputs, intermediate inputs of one or more DNNs. Memory 1004 may store one or more parameters used by the one or more DNNs. Memory 1004 may store information that encodes how nodes of the one or more DNNs are connected with each other. Memory 1004 may store instructions to perform one or more operations of the one or more DNNs. Memory 1004 may store a model definition that specifies one or more operations of a DNN.

In some embodiments, computing device 1000 may include a communication device 1012 (e.g., one or more communication devices). For example, communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 1002.10 family), IEEE 1002.16 standards (e.g., IEEE 1002.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1002.16 compatible Broadband Wireless Access (BWA) networks are generally referred to as WiMAX networks, an acronym that stands for worldwide interoperability for microwave access, which is a certification mark for products that pass conformity and interoperability tests for the IEEE 1002.16 standards. Communication device 1012 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. Computing device 1000 may include an antenna 1022 to facilitate wireless communications and/or to receive other wireless communications (such as radio frequency transmissions). Computing device 1000 may include receiver circuits and/or transmitter circuits. In some embodiments, communication device 1012 may manage wired communications, such as electrical, optical, or any other suitable communication protocols (e.g., the Ethernet). As noted above, communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

Computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

Computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

Computing device 1000 may include an audio output device 1008 (or corresponding interface circuitry, as discussed above). The audio output device 1008 may include any device that generates an audible indicator, such as speakers, headsets, or earbuds, for example.

Computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

Computing device 1000 may include a GPS device 1016 (or corresponding interface circuitry, as discussed above). The GPS device 1016 may be in communication with a satellite-based system and may receive a location of the computing device 1000, as known in the art.

Computing device 1000 may include a sensor 1030 (or one or more sensors). Computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

Computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1000 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1000 may be any other electronic device that processes data.

### Select Examples

Example 1 provides one or more non-transitory computer-readable media storing instructions for simulating a neural network model executable on a neural network accelerator, that when executed by a processor, cause the processor to: receive a configuration having one or more pipelines, where a pipeline of the one or more pipelines includes one or more neural network model executions and one or more scheduling policies; instantiate one or more threads corresponding to the one or more pipelines, a thread of the one or more threads corresponding to a pipeline of the one or more pipelines; decompose a neural network model execution of the one or more neural network model executions into one or more tasks according to one or more parameters of the neural network accelerator; enqueue the one or more tasks of the neural network model execution to the thread; run a software stack simulator that simulates multi-thread scheduling of the one or more threads according to the one or more scheduling policies and resource availability, where the software stack simulator advances a simulation time according to one or more durations corresponding to the one or more tasks and updates one or more states of the one or more threads according to the multi-thread scheduling; run a neural network execution simulator that simulates dispatch and completion of the one or more tasks in one or more task queues according to one or more of task dependency and further resource availability, where the neural network execution simulator advances the simulation time according to one or more durations corresponding to the one or more tasks and updates one or more states of the one or more task queues according to the dispatch and the completion of the one or more tasks; and collect one or more event data points for the one or more tasks and the one or more pipelines based on the simulation time, where the one or more event data points include one or more of: one or more task start times and one or more task completion times associated with the one or more tasks.
Example 2 provides the one or more non-transitory computer-readable media of example 1, where: the one or more neural network model executions include an identifier of a neural network model executions and a quality-of-service value; and the software stack simulator simulates multi-thread scheduling of the one or more threads further according to the quality-of-service value.
Example 3 provides the one or more non-transitory computer-readable media of example 1 or 2, where: the one or more neural network model executions include one or more of: one or more context identifiers and one or more compute tile identifiers.
Example 4 provides the one or more non-transitory computer-readable media of any one of examples 1-3, where the one or more scheduling policies include one or more of: an indicator that indicates whether the one or more neural network model executions are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.
Example 5 provides the one or more non-transitory computer-readable media of any one of examples 1-4, where the software stack simulator simulates multi-thread scheduling of the one or more threads by scheduling the one or more threads based on one or more of: a round-robin schedule, and a first-come-first-served schedule.
Example 6 provides the one or more non-transitory computer-readable media of any one of examples 1-5, where: decomposing the neural network model execution includes decomposing the neural network model execution further into one or more task dependencies; and the software stack simulator advances the simulation time further based on one or more of: a task dependency of the one or more task dependencies being configured, and the task dependency of the one or more task dependencies being triggered.
Example 7 provides the one or more non-transitory computer-readable media of any one of examples 1-6, where: the software stack simulator advances the simulation time further based on one or more of: a cost of loading data onto a processing queue of the thread, a cost of adding a task to the processing queue of the thread, and a cost of adding a data movement task to the processing queue of the thread.
Example 8 provides the one or more non-transitory computer-readable media of any one of examples 1-7, where the instructions further cause the processor to: sample an activity factor at a power node associated with a circuit of the neural network accelerator during an interval; and calculate a power consumption data point at the power node for the interval based on one or more of: the activity factor, a clock frequency, a voltage, a dynamic capacitance of the circuit, and a power mode of the neural network accelerator during the interval.
Example 9 provides the one or more non-transitory computer-readable media of any one of examples 1-9, where the software stack simulator advances the simulation time further based on one or more of: a latency to transition from an active state of the neural network accelerator to an idle state of the neural network accelerator, and a further latency to transition from the idle state to an active state of the neural network accelerator.
Example 10 provides the one or more non-transitory computer-readable media of any one of examples 1-9, where the instructions further cause the processor to: calculate one or more performance metrics based on the one or more event data points, where the one or more performance metrics includes one or more of: a processing queue wait time, a task queue wait time, deadline-miss indicator, per-pipeline latency, a frames per second measurement, an average latency, a deadline-miss rate, and a per-block utilization.
Example 11 provides the one or more non-transitory computer-readable media of any one of examples 1-10, where the instructions further cause the processor to: generate a visualization of task execution over simulation time based on the one or more event data points.
Example 12 provides one or more non-transitory computer-readable media storing instructions for simulating a neural network model executable on a neural network accelerator, that when executed by a processor, cause the processor to: receive a description of the neural network model, where the description includes one or more of: a model definition, an intermediate representation, and a compiled binary representation; decompose the neural network model into one or more tasks based on the description; enqueue the one or more tasks into one or more task queues; run a simulator that simulates dispatch and completion of the one or more tasks in the one or more task queues according to one or more of task dependency and resource availability, where the simulator advances a simulation time according to one or more durations corresponding to the one or more tasks and updates one or more states of the one or more task queues according to the dispatch and the completion of the one or more tasks; and collect one or more event data points for the one or more tasks based on the simulation time and one or more states of the one or more task queues, where the one or more event data points include one or more of: one or more task start times and one or more task completion times associated with the one or more tasks.
Example 13 provides the one or more non-transitory computer-readable media of example 12, where the instructions further cause the processor to: calculate one or more performance metrics based on the one or more event data points.
Example 14 provides the one or more non-transitory computer-readable media of example 12 or 13, where the processor decomposes the neural network model into the one or more tasks by: mapping one or more neural network operations in the description to one or more task types, the one or more task types include one or more of: a memory transfer task, a compute task, and a control task.
Example 15 provides the one or more non-transitory computer-readable media of example 14, where the memory transfer task includes a source, a destination, and a size.
Example 16 provides the one or more non-transitory computer-readable media of example 14 or 15, where the compute task corresponds to a workload executable by one of: a data processing unit of the neural network accelerator, a processing array of the neural network accelerator, a post-processing circuit of the neural network accelerator, and a digital signal processor of the neural network accelerator.
Example 17 provides the one or more non-transitory computer-readable media of any one of examples 14-16, where the control task corresponds to a barrier having one or more producer tasks and one or more consumer tasks.
Example 18 provides the one or more non-transitory computer-readable media of any one of examples 12-17, where the processor decomposes the neural network model into the one or more tasks by: decompose one or more neural network operations in the description into the one or more tasks based on one or more hardware configurations of the neural network accelerator, the one or more hardware configurations include one or more of: a tiling parameter, a stencil configuration, a data width of a digital signal processor of the neural network accelerator, a loop-unrolling factor, a memory capacity, a width of a memory data path.
Example 19 provides the one or more non-transitory computer-readable media of any one of examples 12-18, where the one or more durations are retrieved from a data store having one or more profiled durations measured from executing the one or more tasks on the neural network accelerator.
Example 20 provides the one or more non-transitory computer-readable media of any one of examples 12-18, where the instructions further cause the processor to: sample an activity factor at a power node associated with a circuit of the neural network accelerator during an interval; and calculate a power consumption data point at the power node for the interval based on one or more of: the activity factor, a clock frequency, a voltage, and a dynamic capacitance of the circuit.
Example 21 provides the one or more non-transitory computer-readable media of example 20, where the processor samples the activity factor at the power node by: calculating a ratio of a number of completed tasks within an interval and a number of tasks that the circuit of the neural network accelerator is able to complete, where the circuit is a compute block of the neural network accelerator.
Example 22 provides the one or more non-transitory computer-readable media of example 20, where the processor samples the activity factor at the power node by: calculating a ratio of effective bandwidth and a maximum bandwidth of the circuit of the neural network accelerator, where the circuit is a memory block of the neural network accelerator.
Example 23 provides the one or more non-transitory computer-readable media of any one of examples 20-22, where the processor calculates the power consumption data point by: calculating the power consumption data point further based on a power mode of the neural network accelerator during the interval.
Example 24 provides an apparatus for simulating neural network models executable on a computing system having a host processor and a neural network accelerator, including a processor; and a memory to store instructions, that when executed by the processor, cause the processor to: receive a configuration having one or more pipelines, where a pipeline of the one or more pipelines includes one or more neural network model executions and one or more scheduling policies; instantiate one or more threads corresponding to the one or more pipelines, a thread of the one or more threads corresponding to a pipeline of the one or more pipelines; decompose a neural network model execution of the one or more neural network model executions into one or more tasks according to one or more parameters of the neural network accelerator; enqueue the one or more tasks of the neural network model execution to a task queue of the thread; run a software stack simulator that simulates multi-thread scheduling of the one or more threads according to the one or more scheduling policies and resource availability, where the software stack simulator advances a simulation time according to one or more durations corresponding to the one or more tasks and updates one or more states of the one or more threads according to the multi-thread scheduling; run a neural network execution simulator that simulates dispatch and completion of the one or more tasks in one or more task queues according to one or more of task dependency and further resource availability, where the neural network execution simulator advances the simulation time according to one or more durations corresponding to the one or more tasks and updates one or more states of the one or more task queues according to the dispatch and the completion of the one or more tasks; and collect one or more event data points for the one or more tasks and the one or more pipelines based on the simulation time, where the one or more event data points include one or more of: one or more task start times and one or more task completion times associated with the one or more tasks.
Example 25 provides the apparatus of example 24, where: the one or more neural network model executions include an identifier of a neural network model executions and a quality-of-service value; and the software stack simulator simulates multi-thread scheduling of the one or more threads further according to the quality-of-service value.
Example 26 provides the apparatus of example 24 or 25, where: the one or more neural network model executions include one or more of: one or more context identifiers and one or more compute tile identifiers.
Example 27 provides the apparatus of any one of examples 24-26, where the one or more scheduling policies include one or more of: an indicator that indicates whether the one or more neural network model executions are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.
Example 28 provides the apparatus of any one of examples 24-27, where the software stack simulator simulates multi-thread scheduling of the one or more threads by scheduling the one or more threads based on one or more of: a round-robin schedule, and a first-come-first-served schedule.
Example 29 provides the apparatus of any one of examples 24-28, where: decomposing the neural network model execution includes decomposing the neural network model execution further into one or more task dependencies; and the software stack simulator advances the simulation time further based on one or more of: a task dependency of the one or more task dependencies being configured, and the task dependency of the one or more task dependencies being triggered.
Example 30 provides the apparatus of any one of examples 24-29, where: the software stack simulator advances the simulation time further based on one or more of: a cost of loading data onto a processing queue of the thread, a cost of adding a task to the processing queue of the thread, and a cost of adding a data movement task to the processing queue of the thread.
Example 31 provides the apparatus of any one of examples 24-30, where the instructions further cause the processor to: sample an activity factor at a power node associated with a circuit of the neural network accelerator during an interval; and calculate a power consumption data point at the power node for the interval based on one or more of: the activity factor, a clock frequency, a voltage, a dynamic capacitance of the circuit, and a power mode of the neural network accelerator during the interval.
Example 32 provides the apparatus of any one of examples 24-31, where the software stack simulator advances the simulation time further based on one or more of: a latency to transition from an active state of the neural network accelerator to an idle state of the neural network accelerator, and a further latency to transition from the idle state to an active state of the neural network accelerator.
Example 33 provides the apparatus of any one of examples 24-32, where the instructions further cause the processor to: calculate one or more performance metrics based on the one or more event data points, where the one or more performance metrics includes one or more of: a task queue wait time, deadline-miss indicator, per-pipeline latency, a frames per second measurement, an average latency, a deadline-miss rate, and a per-block utilization.
Example 34 provides the apparatus of any one of examples 24-33, where the instructions further cause the processor to: generate a visualization of task execution over simulation time based on the one or more event data points.
Example 35 provides an apparatus for simulating a neural network model executable on a neural network accelerator, including a processor; and a memory to store instructions, that when executed by the processor, cause the processor to: receive a description of the neural network model, where the description includes one or more of: a model definition, an intermediate representation, and a compiled binary representation; decompose the neural network model into one or more tasks based on the description; enqueue the one or more tasks into one or more task queues; run a simulator that simulates dispatch and completion of the one or more tasks in the one or more task queues according to one or more of task dependency and resource availability, where the simulator advances a simulation time according to one or more durations corresponding to the one or more tasks and updates one or more states of the one or more task queues according to the dispatch and the completion of the one or more tasks; and collect one or more event data points for the one or more tasks based on the simulation time and one or more states of the one or more task queues, where the one or more event data points include one or more of: one or more task start times and one or more task completion times associated with the one or more tasks.
Example 36 provides the apparatus of example 35, where the instructions further cause the processor to: calculate one or more performance metrics based on the one or more event data points.
Example 37 provides the apparatus of example 35 or 36, where the processor decomposes the neural network model into the one or more tasks by: mapping one or more neural network operations in the description to one or more task types, the one or more task types include one or more of: a memory transfer task, a compute task, and a control task.
Example 38 provides the apparatus of example 37, where the memory transfer task includes a source, a destination, and a size.
Example 39 provides the apparatus of example 37 or 38, where the compute task corresponds to a workload executable by one of: a data processing unit of the neural network accelerator, a processing array of the neural network accelerator, a post-processing circuit of the neural network accelerator, and a digital signal processor of the neural network accelerator.
Example 40 provides the apparatus of any one of examples 37-39, where the control task corresponds to a barrier having one or more producer tasks and one or more consumer tasks.
Example 41 provides the apparatus of any one of examples 35-40, where the processor decomposes the neural network model into the one or more tasks by: decompose one or more neural network operations in the description into the one or more tasks based on one or more hardware configurations of the neural network accelerator, the one or more hardware configurations include one or more of: a tiling parameter, a stencil configuration, a data width of a digital signal processor of the neural network accelerator, a loop-unrolling factor, a memory capacity, a width of a memory data path.
Example 42 provides the apparatus of any one of examples 35-41, where the one or more durations are retrieved from a data store having one or more profiled durations measured from executing the one or more tasks on the neural network accelerator.
Example 43 provides the apparatus of any one of examples 35-41, where the instructions further cause the processor to: sample an activity factor at a power node associated with a circuit of the neural network accelerator during an interval; and calculate a power consumption data point at the power node for the interval based on one or more of: the activity factor, a clock frequency, a voltage, and a dynamic capacitance of the circuit.
Example 44 provides the apparatus of example 43, where the processor samples the activity factor at the power node by: calculating a ratio of a number of completed tasks within an interval and a number of tasks that the circuit of the neural network accelerator is able to complete, where the circuit is a compute block of the neural network accelerator.
Example 45 provides the apparatus of example 43, where the processor samples the activity factor at the power node by: calculating a ratio of effective bandwidth and a maximum bandwidth of the circuit of the neural network accelerator, where the circuit is a memory block of the neural network accelerator.
Example 46 provides the apparatus of any one of examples 43-45, where the processor calculates the power consumption data point by: calculating the power consumption data point further based on a power mode of the neural network accelerator during the interval.
Example 47 provides a method for simulating a neural network model executable on a neural network accelerator, the method including receiving a configuration having one or more pipelines, where a pipeline of the one or more pipelines includes one or more neural network model executions and one or more scheduling policies; instantiating one or more threads corresponding to the one or more pipelines, a thread of the one or more threads corresponding to a pipeline of the one or more pipelines; decomposing a neural network model execution of the one or more neural network model executions into one or more tasks according to one or more parameters of the neural network accelerator; enqueuing the one or more tasks of the neural network model execution to a task queue of the thread; running a software stack simulator that simulates multi-thread scheduling of the one or more threads according to the one or more scheduling policies and resource availability, where the software stack simulator advances a simulation time according to one or more durations corresponding to the one or more tasks and updates one or more states of the one or more threads according to the multi-thread scheduling; running a neural network execution simulator that simulates dispatch and completion of the one or more tasks in one or more task queues according to one or more of task dependency and further resource availability, where the neural network execution simulator advances the simulation time according to one or more durations corresponding to the one or more tasks and updates one or more states of the one or more task queues according to the dispatch and the completion of the one or more tasks; and collecting one or more event data points for the one or more tasks and the one or more pipelines based on the simulation time, where the one or more event data points include one or more of: one or more task start times and one or more task completion times associated with the one or more tasks.
Example 48 provides the method of example 47, where: the one or more neural network model executions include an identifier of a neural network model executions and a quality-of-service value; and the software stack simulator simulates multi-thread scheduling of the one or more threads further according to the quality-of-service value.
Example 49 provides the method of example 47 or 48, where: the one or more neural network model executions include one or more of: one or more context identifiers and one or more compute tile identifiers.
Example 50 provides the method of any one of examples 47-49, where the one or more scheduling policies include one or more of: an indicator that indicates whether the one or more neural network model executions are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.
Example 51 provides the method of any one of examples 47-50, where the software stack simulator simulates multi-thread scheduling of the one or more threads by scheduling the one or more threads based on one or more of: a round-robin schedule, and a first-come-first-served schedule.
Example 52 provides the method of any one of examples 47-51, where: decomposing the neural network model execution includes decomposing the neural network model execution further into one or more task dependencies; and the software stack simulator advances the simulation time further based on one or more of: a task dependency of the one or more task dependencies being configured, and the task dependency of the one or more task dependencies being triggered.
Example 53 provides the method of any one of examples 47-52, where: the software stack simulator advances the simulation time further based on one or more of: a cost of loading data onto a processing queue of the thread, a cost of adding a task to the processing queue of the thread, and a cost of adding a data movement task to the processing queue of the thread.
Example 54 provides the method of any one of examples 47-53, further including sampling an activity factor at a power node associated with a circuit of the neural network accelerator during an interval; and calculating a power consumption data point at the power node for the interval based on one or more of: the activity factor, a clock frequency, a voltage, a dynamic capacitance of the circuit, and a power mode of the neural network accelerator during the interval.
Example 55 provides the method of any one of examples 47-54, where the software stack simulator advances the simulation time further based on one or more of: a latency to transition from an active state of the neural network accelerator to an idle state of the neural network accelerator, and a further latency to transition from the idle state to an active state of the neural network accelerator.
Example 56 provides the method of any one of examples 47-55, further including calculating one or more performance metrics based on the one or more event data points, where the one or more performance metrics includes one or more of: a task queue wait time, deadline-miss indicator, per-pipeline latency, a frames per second measurement, an average latency, a deadline-miss rate, and a per-block utilization.
Example 57 provides the method of any one of examples 47-56, further including generating a visualization of task execution over simulation time based on the one or more event data points.
Example 58 provides a method for simulating a neural network model executable on a neural network accelerator, the method including receiving a description of the neural network model, where the description includes one or more of: a model definition, an intermediate representation, and a compiled binary representation; decomposing the neural network model into one or more tasks based on the description; enqueuing the one or more tasks into one or more task queues; running a simulator that simulates dispatch and completion of the one or more tasks in the one or more task queues according to one or more of task dependency and resource availability, where the simulator advances a simulation time according to one or more durations corresponding to the one or more tasks and updates one or more states of the one or more task queues according to the dispatch and the completion of the one or more tasks; and collecting one or more event data points for the one or more tasks based on the simulation time and one or more states of the one or more task queues, where the one or more event data points include one or more of: one or more task start times and one or more task completion times associated with the one or more tasks.
Example 59 provides the method of example 58, further including calculating one or more performance metrics based on the one or more event data points.
Example 60 provides the method of example 58 or 59, where decomposing the neural network model into the one or more tasks includes mapping one or more neural network operations in the description to one or more task types, the one or more task types include one or more of: a memory transfer task, a compute task, and a control task.
Example 61 provides the method of example 60, where the memory transfer task includes a source, a destination, and a size.
Example 62 provides the method of example 60 or 61, where the compute task corresponds to a workload executable by one of: a data processing unit of the neural network accelerator, a processing array of the neural network accelerator, a post-processing circuit of the neural network accelerator, and a digital signal processor of the neural network accelerator.
Example 63 provides the method of any one of examples 60-62, where the control task corresponds to a barrier having one or more producer tasks and one or more consumer tasks.
Example 64 provides the method of any one of examples 58-63, where decomposing the neural network model into the one or more tasks by: decompose one or more neural network operations in the description into the one or more tasks based on one or more hardware configurations of the neural network accelerator, the one or more hardware configurations include one or more of: a tiling parameter, a stencil configuration, a data width of a digital signal processor of the neural network accelerator, a loop-unrolling factor, a memory capacity, a width of a memory data path.
Example 65 provides the method of any one of examples 58-64, where the one or more durations are retrieved from a data store having one or more profiled durations measured from executing the one or more tasks on the neural network accelerator.
Example 66 provides the method of any one of examples 58-64, further including sampling an activity factor at a power node associated with a circuit of the neural network accelerator during an interval; and calculate a power consumption data point at the power node for the interval based on one or more of: the activity factor, a clock frequency, a voltage, and a dynamic capacitance of the circuit.
Example 67 provides the method of example 66, where sampling the activity factor at the power node includes calculating a ratio of a number of completed tasks within an interval and a number of tasks that the circuit of the neural network accelerator is able to complete, where the circuit is a compute block of the neural network accelerator.
Example 68 provides the method of example 66, where sampling the activity factor at the power node includes calculating a ratio of effective bandwidth and a maximum bandwidth of the circuit of the neural network accelerator, where the circuit is a memory block of the neural network accelerator.
Example 69 provides the method of any one of examples 66-68, where calculating the power consumption data point includes calculating the power consumption data point further based on a power mode of the neural network accelerator during the interval.
Example 70 provides an apparatus including means for performing a method according to any one of examples 47-69.
Example 71 provides a computer program product including instructions which, when executed by a processor, cause the processor to perform a method according to any one of examples 47-69.
Example 72 provides a machine-readable storage including machine-readable instructions, when executed, cause a computer to implement a method according to any one of examples 47-69.
Example 73 provides a computer program including instructions which, when the computer program is executed by a processing device, cause the processing device to carry out a method according to any one of examples 47-69.
Example 74 provides a computer-implemented system, including one or more processors, and one or more non-transitory computer-readable media storing instructions that, when executed by the one or more processors, cause the one or more processors to perform a method according to any one of examples 47-69.

### Variations and Other Notes

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed:

1. One or more non-transitory computer-readable media storing instructions for simulating a neural network model executable on a neural network accelerator, that when executed by a processor, cause the processor to:
receive a configuration having one or more pipelines, wherein a pipeline of the one or more pipelines includes one or more neural network model executions and one or more scheduling policies;
instantiate one or more threads corresponding to the one or more pipelines, a thread of the one or more threads corresponding to a pipeline of the one or more pipelines;
decompose a neural network model execution of the one or more neural network model executions into one or more tasks according to one or more parameters of the neural network accelerator;
enqueue the one or more tasks of the neural network model execution to the thread;
run a software stack simulator that simulates multi-thread scheduling of the one or more threads according to the one or more scheduling policies and resource availability, wherein the software stack simulator advances a simulation time according to one or more durations corresponding to the one or more tasks and updates one or more states of the one or more threads according to the multi-thread scheduling;
run a neural network execution simulator that simulates dispatch and completion of the one or more tasks in one or more task queues according to one or more of task dependency and further resource availability, wherein the neural network execution simulator advances the simulation time according to one or more durations corresponding to the one or more tasks and updates one or more states of the one or more task queues according to the dispatch and the completion of the one or more tasks; and
collect one or more event data points for the one or more tasks and the one or more pipelines based on the simulation time, wherein the one or more event data points include one or more of: one or more task start times and one or more task completion times associated with the one or more tasks.

2. The one or more non-transitory computer-readable media of claim 1, wherein:
the one or more neural network model executions include an identifier of a neural network model executions and a quality-of-service value; and
the software stack simulator simulates multi-thread scheduling of the one or more threads further according to the quality-of-service value.

3. The one or more non-transitory computer-readable media of claim 1, wherein:
the one or more neural network model executions include one or more of: one or more context identifiers and one or more compute tile identifiers.

4. The one or more non-transitory computer-readable media of claim 1, wherein the one or more scheduling policies comprise one or more of: an indicator that indicates whether the one or more neural network model executions are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.

5. The one or more non-transitory computer-readable media of claim 1, wherein the software stack simulator simulates multi-thread scheduling of the one or more threads by scheduling the one or more threads based on one or more of: a round-robin schedule, and a first-come-first-served schedule.

6. The one or more non-transitory computer-readable media of claim 1, wherein:
decomposing the neural network model execution comprises decomposing the neural network model execution further into one or more task dependencies; and
the software stack simulator advances the simulation time further based on one or more of: a task dependency of the one or more task dependencies being configured, and the task dependency of the one or more task dependencies being triggered.

7. The one or more non-transitory computer-readable media of claim 1, wherein:
the software stack simulator advances the simulation time further based on one or more of: a cost of loading data onto a processing queue of the thread, a cost of adding a task to the processing queue of the thread, and a cost of adding a data movement task to the processing queue of the thread.

8. The one or more non-transitory computer-readable media of claim 1, wherein the instructions further cause the processor to:
sample an activity factor at a power node associated with a circuit of the neural network accelerator during an interval; and
calculate a power consumption data point at the power node for the interval based on one or more of: the activity factor, a clock frequency, a voltage, a dynamic capacitance of the circuit, and a power mode of the neural network accelerator during the interval.

9. The one or more non-transitory computer-readable media of claim 1, wherein the software stack simulator advances the simulation time further based on one or more of: a latency to transition from an active state of the neural network accelerator to an idle state of the neural network accelerator, and a further latency to transition from the idle state to an active state of the neural network accelerator.

10. The one or more non-transitory computer-readable media of claim 1, wherein the instructions further cause the processor to:
calculate one or more performance metrics based on the one or more event data points, wherein the one or more performance metrics comprises one or more of: a processing queue wait time, a task queue wait time, deadline-miss indicator, per-pipeline latency, a frames per second measurement, an average latency, a deadline-miss rate, and a per-block utilization.

11. The one or more non-transitory computer-readable media of claim 1, wherein the instructions further cause the processor to:
generate a visualization of task execution over simulation time based on the one or more event data points.

12. An apparatus for simulating neural network models executable on a computing system having a host processor and a neural network accelerator, comprising:
a processor; and
a memory to store instructions, that when executed by the processor, cause the processor to:
receive a configuration having one or more pipelines, wherein a pipeline of the one or more pipelines includes one or more neural network model executions and one or more scheduling policies;
instantiate one or more threads corresponding to the one or more pipelines, a thread of the one or more threads corresponding to a pipeline of the one or more pipelines;
decompose a neural network model execution of the one or more neural network model executions into one or more tasks according to one or more parameters of the neural network accelerator;
enqueue the one or more tasks of the neural network model execution to a task queue of the thread;
run a software stack simulator that simulates multi-thread scheduling of the one or more threads according to the one or more scheduling policies and resource availability, wherein the software stack simulator advances a simulation time according to one or more durations corresponding to the one or more tasks and updates one or more states of the one or more threads according to the multi-thread scheduling;
run a neural network execution simulator that simulates dispatch and completion of the one or more tasks in one or more task queues according to one or more of task dependency and further resource availability, wherein the neural network execution simulator advances the simulation time according to one or more durations corresponding to the one or more tasks and updates one or more states of the one or more task queues according to the dispatch and the completion of the one or more tasks; and
collect one or more event data points for the one or more tasks and the one or more pipelines based on the simulation time, wherein the one or more event data points include one or more of: one or more task start times and one or more task completion times associated with the one or more tasks.

13. The apparatus of claim 12, wherein:
the one or more neural network model executions include an identifier of a neural network model executions and a quality-of-service value; and
the software stack simulator simulates multi-thread scheduling of the one or more threads further according to the quality-of-service value.

14. The apparatus of claim 12, wherein:
the one or more neural network model executions include one or more of: one or more context identifiers and one or more compute tile identifiers.

15. The apparatus of claim 12, wherein the one or more scheduling policies comprise one or more of: an indicator that indicates whether the one or more neural network model executions are to be executed sequentially, an indicator that indicates whether parallel or concurrent execution of one or more models is allowed, a time delay offset before the pipeline begins execution, an interval between consecutive activations of the pipeline, and a count of a number of times the pipeline is to be executed.

16. A method for simulating a neural network model executable on a neural network accelerator, the method comprising:
receiving a configuration having one or more pipelines, wherein a pipeline of the one or more pipelines includes one or more neural network model executions and one or more scheduling policies;
instantiating one or more threads corresponding to the one or more pipelines, a thread of the one or more threads corresponding to a pipeline of the one or more pipelines;
decomposing a neural network model execution of the one or more neural network model executions into one or more tasks according to one or more parameters of the neural network accelerator;
enqueuing the one or more tasks of the neural network model execution to a task queue of the thread;
running a software stack simulator that simulates multi-thread scheduling of the one or more threads according to the one or more scheduling policies and resource availability, wherein the software stack simulator advances a simulation time according to one or more durations corresponding to the one or more tasks and updates one or more states of the one or more threads according to the multi-thread scheduling;
running a neural network execution simulator that simulates dispatch and completion of the one or more tasks in one or more task queues according to one or more of task dependency and further resource availability, wherein the neural network execution simulator advances the simulation time according to one or more durations corresponding to the one or more tasks and updates one or more states of the one or more task queues according to the dispatch and the completion of the one or more tasks; and
collecting one or more event data points for the one or more tasks and the one or more pipelines based on the simulation time, wherein the one or more event data points include one or more of: one or more task start times and one or more task completion times associated with the one or more tasks.

17. The method of claim 16, wherein:
the software stack simulator advances the simulation time further based on one or more of: a cost of loading data onto a processing queue of the thread, a cost of adding a task to the processing queue of the thread, and a cost of adding a data movement task to the processing queue of the thread.

18. The method of claim 16, further comprising:
sampling an activity factor at a power node associated with a circuit of the neural network accelerator during an interval; and
calculating a power consumption data point at the power node for the interval based on one or more of: the activity factor, a clock frequency, a voltage, a dynamic capacitance of the circuit, and a power mode of the neural network accelerator during the interval.

19. The method of claim 16, wherein the software stack simulator advances the simulation time further based on one or more of: a latency to transition from an active state of the neural network accelerator to an idle state of the neural network accelerator, and a further latency to transition from the idle state to an active state of the neural network accelerator.

20. The method of claim 16, further comprising:
calculating one or more performance metrics based on the one or more event data points, wherein the one or more performance metrics comprises one or more of: a task queue wait time, deadline-miss indicator, per-pipeline latency, a frames per second measurement, an average latency, a deadline-miss rate, and a per-block utilization.
